(19) United States
(12) Patent Application Publication
(10) Pub. No.: US 2005/0059437 A1
(43) Pub. Date: Mar. 17, 2005

(54) Mode transition method considering handover in a broadband wireless access communication system

(75) Inventors: Yeong-Moon Son, Anyang-si (KR); Chang-Hol Koo, Seongnam-si (KR); Jung-Je Son, Seongnam-si (KR); Sung-Jin Lee, Suwon-si (KR); So-Hyun Kim, Suwon-si (KR); Hyun-Jeong Kang, Seoul (KR)

Correspondence Address: DILWORTH & BARRESE, LLP, 333 EARLE OVINGTON BLVD., UNIONDALE, NY, 11553, US

(73) Assignee: SAMSUNG ELECTRONICS CO., LTD., GYEONGGI-DO (KR)

(21) Appl. No.: 10/933,803

(22) Filed: Sep. 3, 2004

(30) Foreign Application Priority Data
Sep. 4, 2003 (KR) 61946/2003

(51) Int. Cl. H04Q 7/20

(52) U.S. Cl. 455/574

(57) ABSTRACT

Disclosed is a method for enabling a subscriber station to shift from a sleep mode to an awake mode in a broadband wireless access communication system including the sleep mode in which there exists no data to be transmitted between the subscriber station and a base station, and the awake mode in which there exists data to be exchanged between the subscriber station and the base station. The method includes measuring a Carrier-to-Interference and Noise Ratio(CINR) with respect to the base station in a time interval for monitoring a received signal during the sleep mode; and shifting from the sleep mode to the awake mode when the measured signal-to-noise ratio is less than a first threshold value set in advance.

### PRIORITY

This application claims priority to an application entitled “Mode Transition Method Considering Handover In Broadband Wireless Access Communication System” filed in the Korean Intellectual Property Office on Sep. 4, 2003 and assigned Serial No. 2003-61946, the contents of which are hereby incorporated by reference.

### BACKGROUND OF THE INVENTION

1. Field of the Invention

The present invention relates to a broadband wireless access communication system, and more particularly to a method for controlling a handover in a sleep mode and an awake mode of the broadband wireless access communication system employing an orthogonal frequency division multiplexing (‘OFDM’) scheme.

2. Description of the Related Art

In a 4^{th} generation (‘4G’) communication system, which is the next generation communication system, research has been actively pursued to provide users with services having various qualities of service (‘QoS’) and supporting a transmission speed of about 100 Mbps.

A current 3^{rd} generation (‘3G’) communication system supports a transmission speed of about 384 kbps in an outdoor channel environment having a relatively unfavorable channel environment, and supports a maximum transmission speed of 2 Mbps even in an indoor channel environment having a relatively favorable channel environment. Meanwhile, wireless local area network (‘LAN’) systems and wireless metropolitan area network (‘MAN’) systems generally support transmission speeds of 20 to 50 Mbps.

Accordingly, in a current 4G communication system, a new type of communication system ensuring mobility and QoS in the wireless LAN system and the wireless MAN system supporting relatively high transmission speeds, and supporting a high speed service to be provided by the 4G communication system, is currently being developed.

As a result of the research, a sleep mode operation scheme and a handover operation scheme for ensuring the wireless mobility and the QoS of a subscriber station (SS) are proposed to minimize the power consumption of the subscriber station. However, since each of the two operation schemes has been developed only for its own purposes, it is impossible to simultaneously perform both the handover process and the sleep mode operation. However, subscriber stations are required more and more to have mobility and consume lower power.

FIG. 1 is a structure diagram schematically illustrating a structure of a broadband wireless access communication system employing an OFDM scheme and an orthogonal frequency division multiple access (‘OFDMA’) scheme. Specifically, FIG. 1 schematically illustrates a structure of an IEEE(Institute of Electrical and Electronics Engineers) 802.16a communication system, which is the standard specification of the wireless MAN.

The wireless MAN system is a broadband wireless access (BWA) communication system, which has a wider service area and supports a higher transmission speed than the wireless LAN system. The IEEE 802.16a communication system is a system employing an OFDM scheme and an OFDMA scheme in order to enable a physical channel of the wireless MAN system to support a broadband transmission network.

The IEEE 802.16a communication system applies an OFDM/OFDMA scheme to the wireless MAN system, which allows the IEEE 802.16a communication system to transmit a physical channel signal by means of a plurality of sub-carriers, thereby enabling a high speed data transmission.

Meanwhile, an IEEE 802.16e communication system is a system reflecting mobility of a subscriber station in addition to the IEEE 802.16a communication system. Detailed standard proposals for the IEEE 802.16e communication system have not been completely prepared nor been completely defined yet. Both the IEEE 802.16a communication system and the IEEE 802.16e communication system are broadband wireless access communication systems employing the OFDM/OFDMA scheme. Hereinafter, for convenience of description, the IEEE 802.16a communication system will be described as an example.

Further, since the IEEE 802.16e communication system is the system reflecting the mobility of the subscriber station as described above, a mobile station (MS) and a mobile subscriber station (MSS) are used together with the subscriber station (SS) in expressing the subscriber station. That is, the mobile station and the mobile subscriber station conceptually assign mobility to the subscriber station.

Referring to FIG. 1, the IEEE 802.16a communication system has a single cell structure and includes a base station (BS) 100 and a plurality of subscriber stations 110, 120, and 130 controlled by the base station 100. Transmission/reception of signals between the base station 100 and the subscriber stations 110, 120, and 130 is performed according to the OFDM/OFDMA scheme.

As described above, the IEEE 802.16a communication system currently reflects only a single cell structure and only a state in which subscriber stations are fixed, without taking mobility of a subscriber station into consideration at all. Further, as described above, the IEEE 802.16e communication system is defined as a system that takes mobility of a subscriber station into account, in addition to the IEEE 802.16a communication system. Therefore, it is required that the IEEE 802.16e communication system reflect mobility of a subscriber station in a multi-cell environment. In order to provide mobility for a subscriber station in a multi-cell environment, change in operations of the subscriber station and the base station is indispensable. As a result, specific standards are being recently developed for the multi-cell environment and the mobility of the subscriber station in the IEEE 802.16e communication system. Herein, for the convenience of explanation, the subscriber station with mobility is called as a ‘mobile subscriber station(MSS)’

In a case where the mobility of mobile subscriber station is taken into consideration in the IEEE 802.16e communication system, power consumption of the mobile subscriber station plays an important part in the entire system. Therefore, transition between a sleep mode operation and a awake mode operation corresponding to the sleep mode operation has been proposed for the mobile subscriber station and the base station in order to minimize the power consumption of the mobile subscriber station.

FIG. 2 is a diagram schematically illustrating a current sleep mode operation proposed for the IEEE 802.16e communication system.

The sleep mode operation will be briefly described hereinafter, before describing FIG. 2. Utilizing the sleep mode in transmitting packet data has been proposed in order to minimize power consumption of a mobile subscriber station in an idle interval in which packet data are not transmitted. That is, in the sleep mode, a mobile subscriber station and a base station simultaneously state-transit into the sleep mode, thereby minimizing the power consumption of the mobile subscriber station in the idle interval in which packet data are not transmitted.

In general, the packet data are generated in burst intervals. Accordingly, it is unreasonable that the same operation is performed in both an interval in which packet data are not transmitted and an interval in which packet data are transmitted. For this reason, the sleep mode operation as described above has been proposed.

Meanwhile, when packet data to be transmitted are generated while both the mobile subscriber station and the base station are in the sleep mode, the mobile subscriber station and the base station must simultaneously state-transit into the awake mode in order to transmit/receive the packet data.

The sleep mode operation as described above is proposed not only in view of power consumption but also as a scheme for minimizing interference between channel signals. However, since traffic has a large influence on packet data, the sleep mode operation must be performed in consideration of the traffic characteristic and the transmission method characteristic of the packet data. Referring to FIG. 2, reference numeral 211 shows the generation pattern of packet data, which is a plurality of ON intervals and OFF intervals. The ON intervals are burst intervals in which packet data (i.e., traffic) are generated and the OFF intervals are idle intervals in which the traffic is not generated.

The mobile subscriber station and the base station are transited between a sleep mode and an awake mode according to the traffic generation pattern as described above, so that power consumption of the mobile subscriber station can be minimized and interference between channel signals can be prevented.

Reference numeral 213 shows the mode change of a base station and a mobile subscriber station, and a plurality of awake modes and sleep modes. In the awake modes, traffic is generated and an actual exchange of packet data between the mobile subscriber station and the base station is performed. In contrast, in the sleep modes, traffic is not generated and an actual exchange of packet data between the mobile subscriber station and the base station is not performed.

Reference numeral 215 shows the power level of a mobile subscriber station. As illustrated in FIG. 2, when the power level of the mobile subscriber station is K in the awake mode, the power level of the mobile subscriber station is M in the sleep mode. Herein, when the power level K of the mobile subscriber station in the awake mode is compared with the power level M of the mobile subscriber station in the sleep mode, the value of M is much less than the value of K. That is, since the transmission/reception of packet data is not performed in the sleep mode, the power of the mobile subscriber station isless than the awake mode.

Hereinafter, methods proposed up to now by the IEEE 802.16e communication system in order to support the sleep mode operation will be described. However, before describing the schemes having been proposed for the IEEE 802.16e communication system up to now, preconditions will first be described.

In order to state-transits into the sleep mode, a mobile subscriber station must necessarily receive state transition consent from a base station. Further, the base station consents to the transition of the mobile subscriber station to the sleep mode, and transmits packet data.

Also, the base station must inform the mobile subscriber station of the existence of packet data to be transmitted during the listening interval of the mobile subscriber station. Herein, the mobile subscriber station awakes from the sleep mode and confirms whether or not there exist packet data to be transmitted from the base station to the mobile subscriber station. The listening interval will be described later in more detail.

From the result of the confirmation, when there exists the packet data to be transmitted from the base station to the mobile subscriber station, the mobile subscriber station state-transits to the awake mode and receives the packet data from the base station. In contrast, when there exists no packet data to be transmitted from the base station to the mobile subscriber station, the mobile subscriber station may return to the sleep mode again, or it may maintain the awake mode.

Hereinafter, parameters necessary in supporting the sleep mode operation and the awake mode operation will be described.

1) Sleep Interval

The sleep interval is an interval which is requested by a mobile subscriber station and assigned by a base station according to the request of the mobile subscriber station. Also, the sleep interval represents a time interval from a state-transition of the mobile subscriber station into a sleep mode to a state-transition of the mobile subscriber station back into an awake mode. In other words, the sleep interval is defined as an interval in which the mobile subscriber station is in the sleep mode.

The mobile subscriber station may continuously stay in the sleep mode even after the sleep interval. The mobile subscriber station performs an exponentially increasing algorithm by means of preset minimum window value MIN-WINDOW and maximum window value MAX-WINDOW, thereby updating the sleep interval.

The minimum window value is the minimum value of the sleep interval and the maximum window value is the maximum value of the sleep interval. Further, the minimum window value and the maximum window value are expressed by the number of frames and are assigned by the base station. The minimum window value and the maximum window value will be described in detail later.

2) Listening Interval

The listening interval is an interval which is requested by a mobile subscriber station and assigned by a base station according to the request of the mobile subscriber station. Further, the listening interval represents a time interval in which the mobile subscriber station awakes from a sleep mode for a short period of time, synchronizes with the downlink signal of the base station, and receives downlink messages such as traffic indication (TRF_IND) messages.

The traffic indication message is a message representing existence of traffic, i.e., packet data, to be transmitted to the mobile subscriber station. The traffic indication message will be described later. The mobile subscriber station determines whether to stay in the awake mode or to state-transit into the sleep mode again according to the values of the traffic indication message.

3) Sleep Interval Update Algorithm

When the mobile subscriber station state-transits into a sleep mode, the mobile subscriber station determines a sleep interval having a preset minimum window value as a minimum sleep mode interval. After the sleep interval passes, the mobile subscriber station is awakened from the sleep mode for the listening interval and confirms existence or absence of packet data to be transmitted from the base station. As a result of the confirmation, when there exists no packet data to be transmitted, the mobile subscriber station renews the sleep interval to have a value twice as long as that of a previous sleep interval, and continues to stay in the sleep mode.

For instance, when the minimum window value is 2, the mobile subscriber station sets the sleep interval to be 2 frames and stays in the sleep mode for 2 frames. After passage of 2 frames, the mobile subscriber station is awakened from the sleep mode and determines whether or not the traffic indication message has been received. When the traffic indication message has not been received, that is, when there exists no packet data transmitted from the base station to the mobile subscriber station, the subscriber station sets the sleep interval to be 4 frames, which is twice as many as 2 frames, and stays in the sleep mode for 4 frames.

In this way, the sleep interval increases from the minimum window value to a maximum window value, and the update algorithm of the sleep interval is the sleep interval update algorithm.

Messages currently defined in the IEEE 802.16e communication system in order to support the sleep mode operation and the awake mode operation as described above will now be described.

1) Sleep Request(SLP REQ) Message

The sleep request message is transmitted from a mobile subscriber station to a base station and is a message used when the mobile subscriber station requests a state-transition to a sleep mode. The sleep request message contains parameters (i.e., information elements (IEs)) required when the mobile subscriber station operates in the sleep mode. Table 1 shows the format of the sleep request message.

TABLE 1

| SYNTAX | SIZE | NOTES |
|---|---|---|
| SLP-REQ-MESSAGE_FORMAT ( ) { | | |
| MANAGEMENT MESSAGE TYPE = 45 | 8 bits | |
| MIN-WINDOW | 6 bits | |
| MAX-WINDOW | 10 bits | |
| LISTENING INTERVAL | 8 bits | |
| } | | |

The sleep request message is a dedicated message transmitted based on a connection ID (CID) of a mobile subscriber station, and the information elements of the sleep request message shown in Table 1 will be described hereinafter.

As shown in Table 1, the ‘MANAGEMENT MESSAGE TYPE’ is a type of a message being currently transmitted. For instance, when the ‘MANAGEMENT MESSAGE TYPE’ has a value of 45, the ‘MANAGEMENT MESSAGE TYPE’ represents the sleep request message.

The ‘MINIMUM WINDOW’ value represents a requested start value for the sleep interval (measured in frames), and the ‘MAXIMUM WINDOW’ value represents a requested stop value for the sleep interval (measured in frames). That is, as described above for the sleep interval update algorithm, the sleep interval may be updated within a range from the minimum window value to the maximum window value. The ‘LISTENING INTERVAL’ represents a requested listening interval (measured in frames). The ‘LISTENING INTERVAL’ is also expressed by the number of frames.

2) Sleep Response(SLP RSP) Message

The sleep response message is a message in response to the sleep request message. The sleep response message may be used as a message representing whether to approve or deny the state-transition into a sleep mode requested by the mobile subscriber station, or a message representing an unsolicited instruction.

When the sleep response message is used as a message for an unsolicited instruction, a detailed description is omitted here and will be given later. The sleep response message contains information elements required when the mobile subscriber station operates in a sleep mode. Table 2 shows the format of the sleep response message.

TABLE 2

| SYNTAX | SIZE | NOTES |
|---|---|---|
| SLP-RSP-MESSAGE_FORMAT ( ) { | | |
| MANAGEMENT MESSAGE TYPE = 46 | 8 bits | |
| SLEEP-APPROVED | 1 bit | 0: SLEEP-MODE |
| | | REQUEST DENIED |
| IF(SLEEP-APPROVED==0) { | | |
| RESERVED | 7 bits | |
| } ELSE { | | |
| START-TIME | 7 bits | |
| MIN-WINDOW | 6 bits | |
| MAX-WINDOW | 10 bits | |
| LISTENING INTERVAL | 8 bits | |
| } | | |
| } | | |

The sleep response message also is a dedicated message transmitted based on the connection ID of a subscriber station, and the sleep response message includes information elements as shown in Table 2, which will be described hereinafter.

As shown in Table 2, the ‘MANAGEMENT MESSAGE TYPE’ is a type of a message currently being transmitted. For instance, when the ‘MANAGEMENT MESSAGE TYPE’ has a value of 46, the ‘MANAGEMENT MESSAGE TYPE’ represents the sleep response message. Further, the value of the ‘SLEEP-APPROVED’ is expressed by one bit. Therefore, when the ‘SLEEP-APPROVED’ has a value of 0, it implies that the request for the transition into the sleep mode has been denied (SLEEP-MODE REQUEST DENIED). In contrast, when the ‘SLEEP-APPROVED’ has a value of 1, it implies that the request for the transition into the sleep mode has been approved (SLEEP-MODE REQUEST APPROVED). Further, when the ‘SLEEP-APPROVED’ has a value of 0, reserved areas of 7 bits exist. In contrast, when the ‘SLEEP-APPROVED’ has a value of 1, a start time value, a minimum window value, a maximum window value, and a listening interval exist.

Herein, the value of the ‘START-TIME’ is the number of frames (not including the frame in which the message has been received) until the mobile subscriber station enters a first sleep interval. Accordingly, a frame having received the sleep response message is not contained. That is, the mobile subscriber station state-transits into a sleep mode after frames corresponding to the start time value have passed from a frame directly after the frame carrying the received sleep response message.

The value of the ‘MIN-WINDOW’ represents a start value for the sleep interval (measured in frames) and the value of the ‘MAX-WINDOW’ represents a stop value for the sleep interval (measured in frames). The value of the ‘LISTENING INTERVAL’ is a value for a requested listening interval (measured in frames).

3) Traffic Indication(TRF IND) Message The traffic indication message is a message transmitted to a mobile subscriber station during the listening interval and a message representing the existence of packet data to be transmitted from a base station to the mobile subscriber station. Table 3 shows the format of the traffic indication message.

TABLE 3

| SYNTAX | SIZE | NOTES |
|---|---|---|
| TRF-IND-MESSAGE_FORMAT ( ) { | | |
| MANAGEMENT MESSAGE TYPE = 47 | 8 bits | |
| POSITIVE_INDICATION_LIST ( ) { | | TRAFFIC HAS BEEN |
| | | ADDRESSED |
| NUM-POSITIVE | 8 bits | |
| For (i=0; i<NUM- POSITIVE; i++) { | | |
| CID | 16 bits | BASIC CID OF |
| | | THE SS |
| ] | 8 bits | |
| } | 7 bits | |
| } | | |

The traffic indication message is a broadcasting message transmitted according to the broadcasting method, different from the sleep request message and the sleep response message. The traffic indication message is a message representing existence or absence of packet data to be transmitted from the base station to a predetermined mobile subscriber station. The mobile subscriber station decodes the broadcasted traffic indication message during the listening interval and determines whether to state-transit into an awake mode or to continuously stay in the sleep mode.

When the mobile subscriber station state-transits into the awake mode, the mobile subscriber station confirms a frame sync. As a result of the confirmation, when the frame sync does not coincide with a frame sequence number expected by the mobile subscriber station, the mobile subscriber station can request retransmission of packet data lost in the awake mode. Meanwhile, when the mobile subscriber station fails to receive the traffic indication message during the listening interval, or the traffic indication message received by the mobile subscriber station does not contain a positive indication, the mobile subscriber station returns to the sleep mode. Hereinafter, the information elements of the traffic indication message shown in Table 3 will be described.

As shown in Table 3, the ‘Management Message Type’ is information representing the kind of a message currently being transmitted. For instance, when the ‘Management Message Type’ has a value of 47, the ‘Management Message Type’ represents the traffic indication message. Further, the ‘POSITIVE_INDICATION_LIST’ includes values of NUM-POSITIVE (the number of positive subscribers) and CID (connection ID) of each positive subscriber. Consequently, the ‘POSITIVE_INDICATION_LIST’ represents the number of subscriber stations and the connection IDs of the subscriber stations.

Hereinafter, an operation of a mobile subscriber station, which state-transits into a sleep mode according to the request of the mobile subscriber station, will be described with reference to FIG. 3. FIG. 3 is a signal flowchart illustrating a state-transition process to a sleep mode of the mobile subscriber station according to the request of the mobile subscriber station, which is proposed for the IEEE 802.16e communication system.

Referring to FIG. 3, when the mobile subscriber station 300 intends to state-transit into the sleep mode, the subscriber station 300 transmits a sleep request message to a base station 350 at step 311. Herein, the sleep request message includes the information elements as described in Table 1. Further, the base station 350 having received the sleep request message from the mobile subscriber station 300 determines whether or not to approve the request for the state-transition into the sleep mode by the mobile subscriber station 300 in consideration of the situations of the mobile subscriber station 300 and the base station 350. According to the result of the determination, the base station 350 transmits a sleep response message to the mobile subscriber station 300 at step 313.

Herein, the base station 350 determines whether or not to approve the request for the state-transition into the sleep mode by the mobile subscriber station 300 in consideration of whether or not packet data must be transmitted to the mobile subscriber station 300. That is, as described in Table 2, when approving the request for the state-transition into the sleep mode by the mobile subscriber station 300, the base station 350 sets the ‘SLEEP-APPROVED’ to have a value of 1. In contrast, when denying the request for the state-transition to the sleep mode by the mobile subscriber station 300, the base station 350 sets the ‘SLEEP-APPROVED’ to have a value of 0. The information elements contained in the sleep response message are the same as described in Table 2.

Next, the mobile subscriber station 300 having received the sleep response message from the base station 350 confirms the value of the ‘SLEEP-APPROVED’. As a result of the confirmation, when the request for the state-transition to the sleep mode has been approved, the mobile subscriber station 300 state-transits into the sleep mode at step 315. In contrast, when the request for the state-transition to the sleep mode has been denied, the mobile subscriber station 300 stays in the current mode, that is, an awake mode.

Further, when the mobile subscriber station 300 state-transits into the sleep mode, the mobile subscriber station 300 reads corresponding information elements from the sleep response message and performs a sleep mode operation.

An operation of a mobile subscriber station, which state-transits into a sleep mode according to the control of a base station, will be described with reference to FIG. 4, which is a signal flowchart illustrating a state-transition process to a sleep mode of the mobile subscriber station according to the control of the base station, which has been proposed for the IEEE 802.16e communication system.

Before describing FIG. 4, it is noted that the IEEE 802.16e communication system has also proposed a method for using the sleep response message as a message representing an unsolicited instruction. An unsolicited instruction signifies that the subscriber station operates according to the instruction (i.e., control) of the base station even without a separate request by the mobile subscriber station. FIG. 4 shows a case in which the mobile subscriber station state-transits into the sleep mode according to an unsolicited instruction.

First, the base station 450 transmits the sleep response message to the mobile subscriber station 400 at step 411 which includes the same information elements as described in Table 2. The mobile subscriber station 400 having received the sleep response message from the base station 450 confirms the value of the ‘SLEEP-APPROVED’ contained in the sleep response message. As a result of the confirmation, when the request for the state-transition to the sleep mode has been approved, the mobile subscriber station 400 state-transits into the sleep mode at step 413.

In FIG. 4, since the sleep response message is used as an unsolicited instruction message, the value of the ‘SLEEP-APPROVED’ is expressed only as ‘1’. Further, when the mobile subscriber station 400 state-transits into the sleep mode, the mobile subscriber station 400 reads corresponding information elements from the sleep response message and performs the sleep mode operation.

An operation by which the mobile subscriber station state-transits into an awake mode according to the control of the base station will be described with reference to FIG. 5. FIG. 5 is a signal flowchart illustrating a state-transition process to an awake mode of the mobile subscriber station according to the control of the base station, which has been proposed for the IEEE 802.16e communication system.

Referring to FIG. 5, first, when traffic to be transmitted to the mobile subscriber station 500 is generated, that is, when packet data are generated, the base station 550 transmits a traffic indication message to the mobile subscriber station 500 at step 511. Herein, the traffic indication message includes the information elements as described in Table 3.

Then, the mobile subscriber station 500 having received the traffic indication message from the base station 550 inspects whether or not the traffic indication message contains a positive indication. As a result of the inspection, when the traffic indication message contains a positive indication, the mobile subscriber station 500 reads a connection ID (CID) contained in the traffic indication message and inspects whether or not the mobile subscriber station's own connection ID is contained in the traffic indication message. As a result of the inspection, when the connection ID of the mobile subscriber station 500 is contained in the traffic indication message, the mobile subscriber station 500 state-transits from a current mode, that is, a sleep mode, into the awake mode at step 513.

The above description relates to the sleep mode operation having been proposed for the IEEE 802.16e communication system up to now.

Next, a handover considering the mobility of a mobile subscriber station in a multi-cell structure of the IEEE 802.16e communication system will be described with reference to FIG. 6 FGI. 6 is a diagram schematically illustrating the downlink frame of the conventional broadband wireless access communication system employing an OFDM/OFDMA scheme.

Referring to FIG. 6, the downlink frame includes a preamble portion 600, a broadcast control portion 610, and a plurality of time division multiplex (‘TDM’) portions 620 and 630. A synchronization signal (i.e., preamble sequence) used in obtaining a mutual synchronization between a base station and a mobile subscriber station is transmitted through the preamble portion 600. The broadcast control portion 610 includes a downlink_MAP(‘DL_MAP’) portion 611 and an uplink _MAP(‘UL_MAP’) portion 613. The DL_MAP portion 611 is a portion through which a DL_MAP message is transmitted. Table 4 illustrates information elements (IEs) contained in the DL_MAP message.

TABLE 4

| Syntax | Size | Notes |
|---|---|---|
| DL_MAP_Message_Format( ) { | | |
| Management Message Type=2 | 8 bits | |
| PHY Synchronization Field | Variable | See Appropriate PHY |
| | | specification |
| DCD Count | 8 bits | |
| Base Station ID | 48 bits | |
| Number of DL_MAP Element n | 16 bits | |
| Begin PHY specific section { | | See Applicable PHY |
| | | section |
| for (i=1; i<=n; i++) | | For each DL_MAP |
| | | element 1 to n |
| DL_MAP Information Element( ) | Variable | See corresponding |
| | | PHY specification |
| If!(byte boundary) { | 4 bits | Padding to reach |
| Padding Nibble | | byte boundary |
| } | | |
| } | | |
| } | | |
| } | | |

As shown in Table 4, the DL_MAP message includes a plurality of IEs, that is, the ‘Management Message Type’ representing the type of a transmitted message, the ‘PHYsical (PHY) Synchronization’ set according to a modulation method and a demodulation method applied to a physical channel in order to obtain a synchronization, the ‘DCD count’ representing a count corresponding to the configuration variation of a downlink channel descriptor (‘DCD’) message containing a downlink burst profile, the ‘Base Station ID’ representing a base station identifier (BSID), and the ‘Number of DL_MAP Elements n’ representing the number of elements existing after the Base Station ID. In particular, the DL_MAP message contains information on ranging codes assigned to each ranging which will be described later.

Further, the UL_MAP portion 613 is a portion through which an UL_MAP message is transmitted. Table 5 illustrates IEs contained in the UL_MAP message.

TABLE 5

| Syntax | Size | Notes |
|---|---|---|
| UL_MAP_Message_Format( ) { | | |
| Management Message Type=3 | 8 bits | |
| Uplink Channel ID | 8 bits | |
| UCD Count | 8 bits | |
| Number of UL_MAP Element n | 16 bits | |
| Allocation Start Time | 32 bits | |
| Begin PHY specific section { | | See Applicable |
| | | PHY section |
| for (i=1; i<=n; i++) | | For each UL_MAP |
| | | element 1 to n |
| UL_MAP_Information_Element( ) | Variable | See corresponding |
| | | PHY specification |
| } | | |
| } | | |
| } | | |

As shown in Table 5, the UL_MAP message includes a plurality of IEs, that is, the ‘Management Message Type’ representing the type of a transmitted message, the ‘Uplink Channel ID’ representing a used uplink channel identifier, the ‘UCD count’ representing a count corresponding to the configuration variation of an uplink channel descriptor (‘UCD’) message containing an uplink burst profile, and the ‘Number of UL_MAP Elements n’ representing the number of elements existing after the UCD count. Herein, the uplink channel identifier is uniquely assigned in a medium access control (‘MAC’) sub-layer. Further, the TDM portions 620 and 630 are portions corresponding to time slots assigned to each mobile subscriber station by a TDM/time division multiple access (‘TDMA’) scheme. The base station transmits broadcast information, which must be broadcasted, to mobile subscriber stations managed by the base station through the DL_MAP portion 611 of the downlink frame by means of a preset center carrier. Then, each of the mobile subscriber stations is powered on, monitors all frequency bands set in each of the mobile subscriber stations in advance, and detects a pilot channel signal having the highest pilot carrier to interference and noise ratio (‘CINR’).

Also, the mobile subscriber station determines a base station having transmitted the pilot channel signal having the highest CINR to be a base station to which the mobile subscriber station currently belongs. Further, the mobile subscriber station confirms the DL_MAP portion 611 and the UL_MAP portion 613 of the downlink frame transmitted by the base station, and confirms control information controlling an uplink and a downlink of the mobile subscriber station and information representing an actual position of data transmission/reception.

Table 6 illustrates the structure of the UCD message.

TABLE 6

| Syntax | Size | Notes |
|---|---|---|
| UCD-message_Format( ) { | | |
| Management Message Type=0 | 8 bits | |
| Uplink Channel ID | 8 bits | |
| Configuration Change Count | 8 bits | |
| Mini-slot size | 8 bits | |
| Ranging Backoff Start | 8 bits | |
| Ranging Backoff End | 8 bits | |
| Request Backoff Start | 8 bits | |
| Request Backoff End | 8 bits | |
| TLV Encoded Information for the overall channel | Variable | |
| Begin PHY Specific Section { | | |
| for(i=1; i<=n; i+n) | | |
| Uplink_Burst_Descriptor | Variable | |
| } | | |
| } | | |
| } | | |

As illustrated in Table 6, the UCD message includes a plurality of IEs, that is, the ‘Management Message Type’ representing the type of a transmitted message, the ‘Uplink Channel ID’ representing a used uplink channel identifier, the ‘Configuration Change Count’ counted by a base station, the ‘Mini-slot Size’ representing the size of a mini-slot of an uplink physical channel, the ‘Ranging Backoff Start’ representing a start point of a backoff using an initial ranging (that is, the size of an initial backoff window using an initial ranging), the ‘Ranging Backoff End’ representing an end point of a backoff using an initial ranging (that is, the size of a final backoff window), the ‘Request Backoff Start’ representing a start point of a backoff for ‘contention data and requests’ (that is, the size of an initial backoff window), and the ‘Request Backoff End’ representing an end point of a backoff for ‘contention data and requests’ (that is, the size of a final backoff window).

The value of the backoff represents a kind of waiting time value for which a mobile subscriber station must wait for the next ranging when failure occurs in rangings, which will be described later. Further, a base station must transmit the backoff value, which is information on a time period for which the mobile subscriber station must wait for the next ranging, to the subscriber station when the mobile subscriber station fails in a ranging. For instance, when a value of the Ranging Backoff Start and the Ranging Backoff End is set to be 10, the mobile subscriber station passes a chance in which the mobile subscriber station can perform rangings of 2¹⁰ times (i.e., 1024 times) and then must perform the next ranging.

Hereinafter, the structure of the uplink frame of the conventional IEEE 802.16a communication system will be described with reference to FIG. 7. Herein, the structure of the uplink frame of the conventional IEEE 802.16a communication system is equal to structure of the uplink frame of the conventional IEEE 802.16e communication system. Hereinafter, for convenience of description, the IEEE 802.16a communication system will be described as an example. FIG. 7 is a diagram schematically illustrating the structure of the uplink frame of the conventional broadband wireless access communication system employing an OFDM/OFDMA scheme, and in particular, FIG. 7 is a diagram schematically illustrating the structure of the uplink frame of the IEEE 802.16a communication system.

Before describing FIG. 7, rangings used in the IEEE 802.16a communication system, that is, an initial ranging, a maintenance ranging, i.e. a periodic ranging, and a bandwidth request ranging will be described.

First, the initial ranging will be described.

The initial ranging is a ranging performed when a base station requests the initial ranging in order to obtain synchronization with a subscriber station(SS). Further, the initial ranging is a ranging performed in order to match an exact time offset between the subscriber station and the base station and adjust transmit power. That is, the subscriber station is powered on, receives a DL_MAP message, an UL_MAP message and an UCD message, and obtains synchronization with the base station. Then, the subscriber station performs the initial ranging to adjust the time offset and the transmit power with the base station. Since the IEEE 802.16a communication system employs an OFDM/OFDMA scheme, the ranging procedure requires ranging sub-channels and ranging codes, and a base station assigns usable ranging codes (RCs) according to the object of a ranging, that is, the type of a ranging. This will be described in detail.

The ranging code is generated by segmenting a pseudo-random noise (‘PN’) sequence having a predetermined length (e.g., length of 2¹⁵-1 bits) by a predetermined unit. Generally, two sub-channels having a length of 53 bits constitute one ranging channel. Further, the ranging code is constructed by segmenting a PN code through the ranging channel having a length of 106 bits. The maximum 48 ranging codes RC#1 to RC#48 constructed in this way may be assigned to a subscriber station, and a minimum two ranging codes per subscriber station are applied to three kinds of rangings, that is, the initial ranging, the periodic ranging and the bandwidth request ranging, according to a default value. In this way, different ranging codes are assigned to each ranging. For instance, N number of ranging codes are assigned for the initial ranging (N RCs for initial ranging), M number of ranging codes are assigned for the periodic ranging (M RCs for periodic ranging), and L number of ranging codes are assigned for the bandwidth request ranging (L RCs for BW-request ranging). The ranging codes assigned in this way are transmitted to subscriber stations through the DL_MAP message as described above, and the subscriber stations perform the ranging procedure by using the ranging codes contained in the DL_MAP message according to the objects of the ranging code.

Second, the periodic ranging will be described.

The periodic ranging is a ranging periodically performed when the subscriber station having adjusted the time offset and the transmit power with the base station through the initial ranging adjusts a channel status, etc., with the base station. The subscriber station performs the periodic ranging by means of the ranging codes assigned for the periodic ranging.

Third, the bandwidth request ranging will be described.

The bandwidth request ranging is a ranging performed when the subscriber station having adjusted the time offset and the transmit power with the base station through the initial ranging requests a bandwidth assignment in order to actually perform a communication with the base station.

Referring to FIG. 7, the uplink frame includes an ‘Initial Maintenance Opportunities’ portion 700 using the initial ranging, and the maintenance ranging, that is, the periodic ranging, a ‘Request Contention Opportunities’ portion 710 using the bandwidth request ranging, and a ‘SS scheduled data’ portion 720 containing uplink data of subscriber stations. The Initial Maintenance Opportunities portion 700 includes a plurality of access burst intervals actually containing an initial ranging and a periodic ranging, and a collision interval in which collision between access burst intervals occurs. The Request Contention Opportunities portion 710 includes a plurality of bandwidth request intervals actually containing bandwidth request ranging, and a collision interval in which collision between bandwidth request intervals occurs. Further, the SS scheduled data portion 720 includes a plurality of SS scheduled data parts SS I scheduled data part to SS N scheduled data part, and a subscriber station transition gap exists in each of the SS scheduled data parts.

Meanwhile, an uplink interval usage code (‘UIUC’) portion is a portion in which information designating the use of an offset recorded in an offset portion is recorded.

FIG. 8 is a flowchart schematically illustrating a communication procedure of a broadband wireless access communication system through messages described in FIGS. 6 and 7.

Referring to FIG. 8, the subscriber station 800 is powered on, monitors all frequency bands set in the subscriber station 800 in advance, and detects a pilot channel signal having the highest CINR. Also, the subscriber station 800 determines a base station 820 having transmitted the pilot channel signal having the highest CINR to be the base station 820 to which the subscriber station 800 currently belongs. Then, the subscriber station 800 receives the preamble of the downlink frame transmitted from the base station 820 and obtains a system synchronization with the base station 820.

As described above, when the system synchronization is obtained between the subscriber station 800 and the base station 820, the base station 820 transmits a DL_MAP message and an UL_MAP message to the subscriber station 800 in steps 811 and 813, respectively. Herein, as described in Table 1, the DL_MAP message performs a function of informing the subscriber station 800 of information required when the subscriber station 800 obtains a synchronization with respect to the base station 820 in a downlink, and information on the structure of a physical channel capable of receiving messages transmitted to the subscriber station 800 in the downlink. Further, as described in Table 2, the UL_MAP message performs a function of informing the subscriber station 800 of information on the scheduling period of a subscriber station and the structure of a physical channel in an uplink.

Meanwhile, the DL_MAP message is broadcasted from a base station to all subscriber stations. Herein, when a certain subscriber station can continuously receive the DL_MAP message, it signifies that the subscriber station has synchronized with the base station. That is, the subscriber stations having received the DL_MAP message can receive all messages transmitted through a downlink.

Further, as described in Table 6, when the subscriber station fails in an access, the base station transmits the UCD message containing information notifying an usable backoff value to the subscriber station.

Meanwhile, when the subscriber station 800 having synchronized with the base station 820 performs the ranging, the subscriber station 800 transmits a ranging request (‘RNG-REQ’) message to the base station 820 in step 815. Then, in step 817, the base station 820 having received the RNG_REQ message transmits a ranging response (‘RNG_RSP’) message, which contains information for compensating for a frequency, a time, and transmit power for the ranging, to the subscriber station 800.

Table 7 shows the structure of the RNG_REQ message.

TABLE 7

| Syntax | Size | Notes |
|---|---|---|
| RNG_REQ_message_Format( ) { | | |
| Management Message Type=4 | 8 bits | |
| Downlink Channel ID | 8 bits | |
| Pending Until Complete | 8 bits | |
| TLV Encoded Information | Variable | TLV specific |
| } | | |

As illustrated in Table 7, the ‘Downlink Channel ID’ represents a downlink channel identifier contained in the RNG_REQ message received in the subscriber station 800 through the UCD. The ‘Pending Until Complete’ represents a priority of a transmitted ranging response. That is, when the Pending Until Complete has a value of 0, a previous ranging response has a high priority. In contrast, when the Pending Until Complete has values other than 0, a currently transmitted ranging response has a high priority.

Table 8 shows the structure of the RNG_RSP message corresponding to the RNG_REQ message shown in Table 7.

TABLE 8

| Syntax | Size | Notes |
|---|---|---|
| RNG_RSP_message_Format( ) { | | |
| Management Message Type=5 | 8 bits | |
| Uplink Channel ID | 8 bits | |
| TLV Encoded Information | Variable | TLV specific |
| } | | |

As shown in Table 8, the ‘Uplink Channel ID’ represents an uplink channel identifier contained in the RNG_REQ message.

Meanwhile, as described above, the IEEE 802.16a communication system considers only a state in which a subscriber station is currently motionless (i.e., a state in which the mobility of the subscriber station is not entirely considered), and a single cell structure. However, an IEEE 802.16e communication system is a system that considers the mobility of a subscriber station in an IEEE 802.16a communication system. Accordingly, the IEEE 802.16e communication system must consider the mobility of a subscriber station, i.e., a mobile subscriber station in a multi-cell environment. In order to support the mobility of the mobile subscriber station in a multi-cell environment, changes in operations of the mobile subscriber station and a base station are necessarily required. In particular, in order to support the mobility of the mobile subscriber station, a procedure for a handover of the mobile subscriber station considering a multi-cell structure is being developed.

FIG. 9 is a structure diagram schematically illustrating the structure of the IEEE 802.16e communication system. Referring to FIG. 9, the IEEE 802.16e communication system has a multi-cell structure, that is, a cell 900 and a cell 950. Further, the IEEE 802.16e communication system includes a base station 910 controlling the cell 900, a base station 940 controlling the cell 950, and a plurality of mobile subscriber stations 911, 913, 930, 951, and 953. The transmission/reception of signals between the base stations 910 and 940 and the mobile subscriber stations 911, 913, 930, 951, and 953 is accomplished using an OFDM/OFDMA scheme. Herein, the mobile subscriber station 930 of the mobile subscriber stations 911, 913, 930, 951, and 953 stays in an overlapping area (i.e., handover area) between the cell 900 and the cell 950. Accordingly, only when a handover for the mobile subscriber station 930 must be supported, it is possible to support the mobility for the mobile subscriber station 930.

In the broadband wireless access communication system, a certain mobile subscriber station receives pilot channels transmitted from a plurality of base stations, and measures CINRs of the received pilot channels. The mobile subscriber station selects a base station having the highest CINR from among the measured CINRs. That is, the mobile subscriber station selects a base station having the best reception status from among the base stations transmitting the pilot channels and thus recognizes a base station to which the mobile subscriber station belongs. Hereinafter, the base station having the best reception status will be called a serving base station. The subscriber station having selected the serving base station receives the downlink frame of FIG. 6 and the uplink frame of FIG. 7 transmitted from the serving base station.

The serving base station transmits a mobile subscriber station neighbor advertisement (‘MOB_NBR_ADV’) message to the mobile subscriber station. Table 9 illustrates the structure of the MOB_NBR_ADV message.

TABLE 9

| Syntax | Size | Notes |
|---|---|---|
| MOB_NBR_ADV_message_Format( ) { | | |
| Management Message Type=48 | 8 bits | |
| Configuration Change Count | 8 bits | |
| N_NEIGHBORS | 8 bits | |
| For (j=0;j< N_NEIGHBORS;J++){ | | |
| Neighbor BS-ID | 48 bits | |
| Physical Frequency | 32 bits | |
| TLV Encoded Neighbor Information | Variable | TLV specific |
| } | | |
| } | | |

As shown in Table 9, the MOB_NBR_ADV message includes a plurality of IEs, that is, the ‘Management Message Type’ representing the type of transmitted message, the ‘Configuration Change Count’ representing the number of times by which a Configuration changes, the ‘N_NEIGHBORS’ representing the number of neighbor base stations, the ‘Neighbor BS-ID’ representing identifiers (ID) of the neighbor base stations, the ‘Physical Frequency’ representing the physical frequency of the neighbor base station, and the ‘TLV (Type, Length, Value) Encoded Neighbor Information’ representing extra information relating to the neighbor base station in addition to the information.

The mobile subscriber station having received the MOB_NBR_ADV message transmits a mobile subscriber station scanning interval allocation request (‘MOB_SCN_REQ’) message to the serving base station when the mobile subscriber station intends to scan the CINRs of pilot channel signals transmitted from neighbor base stations. Herein, since a timing point at which the mobile subscriber station requests a scanning has no direct relation to a scanning operation for the CINR of the pilot channel signal, a detailed description about the time point will be omitted. Table 10 illustrates the structure of the MOB_SCN_REQ message.

TABLE 10

| Syntax | Size | Notes |
|---|---|---|
| MOB_SCN_REQ_message_Format( ) { | | |
| Management Message Type=? | 8 bits | |
| Scan Duration | 16 bits | Units are frames |
| } | | |

As illustrated in Table 10, the MOB_SCN_REQ message includes a plurality of IEs, that is, the ‘Management Message Type’ representing the type of transmitted message and the ‘Scan Duration’ representing a scan duration for which the mobile subscriber station scans the CINRs of the pilot channel signals transmitted from the neighbor base stations. The ‘Scan Duration’ is constructed by the frame. Herein, the ‘Management Message Type’ of the MOB_SCN_REQ message to be transmitted has not been defined yet (i.e., Management Message Type=undefined).

Meanwhile, the serving base station having received the MOB_SCN_REQ message transmits a mobile subscriber station scanning interval allocation response (‘MOB_SCN_RSP’) message, which contains information to be scanned by the mobile subscriber station, to the mobile subscriber station. Table 11 illustrates the structure of the MOB_SCN_RSP message.

TABLE 11

| Syntax | Size | Notes |
|---|---|---|
| MOB_SCN_RSP_message_Format( ) { | | |
| Management Message Type=? | 8 bits | |
| Length | 8 bits | in bytes |
| For(i=0;i<Length/3;i++){ | | |
| CID | 16 bits | basic CID of the MSS |
| Duration | 8 bits | in frames |
| } | | |
| } | | |

As illustrated in Table 11, the MOB_SCN_RSP message includes a plurality of IEs, that is, the ‘Management Message Type’ representing the type of transmitted message, the connection ID (‘CID’) of the mobile subscriber station having transmitted the MOB_SCN_REQ message, and a scan duration. In Table 11, the ‘Management Message Type’ of the MOB_SCN_RSP message to be transmitted has not been defined yet (i.e., Management Message Type=undefined), and the scan duration is a duration for which the mobile subscriber station performs the pilot channel CINR scanning. The mobile subscriber station having received the MOB_SCN_RSP message containing the scanning information scans pilot channel CINRs for neighbor base stations, which has been recognized through the MOB_NBR_ADV message, according to the scanning information parameters.

In order to support a handover in the IEEE 802.16e communication system, a mobile subscriber station must measure CINRs of pilot channel signals transmitted from neighbor base stations and a base station (i.e., serving base station) to which the mobile subscriber station currently belongs. Further, when the CINR of the pilot channel signal transmitted from the serving base station is less than the CINRs of the pilot channel signals transmitted from the neighbor base stations, the mobile subscriber station requests a handover to the serving base station. Herein, for convenience of description, the phrase ‘measure the CINR of the pilot channel signal’ may be expressed by ‘scan or perform a scanning for the CINR of the pilot channel signal’.

FIG. 10 is a signal flowchart schematically illustrating the handover request process by the mobile subscriber station in the conventional broadband wireless access communication system employing an OFDM/OFDMA scheme, and in particular, FIG. 10 schematically illustrates the handover process of the mobile subscriber station by the request of the mobile subscriber station in the IEEE 802.16e communication system.

Referring to FIG. 10, first, a serving base station(SERVING BS) 1040 transmits a MOB_NBR_ADV message to a mobile subscriber station 1000 in step 1011. Then, the mobile subscriber station 1000 receives the MOB_NBR_ADV message and obtains information on neighbor base stations. Further, in step 1013, the mobile subscriber station 1000 transmits a MOB_SCN_REQ message to the serving base station 1040 when the mobile subscriber station 1000 intends to scan the CINRs of pilot channel signals transmitted from the neighbor base stations. Herein, since a timing point at which the mobile subscriber station 1000 requests a scanning has no direct relation to a scanning operation for the CINR of the pilot channel signal, a detailed description about the time point will be omitted. Meanwhile, in step 1015, the serving base station 1040 having received the MOB_SCN_REQ message transmits the MOB_SCN_RSP message, which contains information to be scanned by the mobile subscriber station 1000, to the mobile subscriber station 1000. In step 1017, the mobile subscriber station 1000 having received the MOB_SCN_RSP message containing the scanning information performs a scanning for the CINRs of pilot channel signals with respect to neighbor base stations, which has been recognized through the reception of the MOB_NBR_ADV message, according to parameters (i.e., scan duration) contained in the MOB_SCN_RSP message.

Next, after having completed the scan of the CINRs of the pilot channel signals received from the neighbor base stations, when the mobile subscriber station 1000 determines to change the serving base station 1040 to which the mobile subscriber station 1000 currently belongs in step 1019, that is, the mobile subscriber station 1000 determines to change the current serving base station 1040 to another new base station, the mobile subscriber station 1000 transmits a mobile subscriber station handover request (‘MOB_MSSHO_REQ’) message to the serving base station 1040 in step 1021.

Table 12 illustrates the structure of the MOB_MSSHO_REQ message.

TABLE 12

| Syntax | Size | Notes |
|---|---|---|
| MOB_MSSHO_REQ_message_Format( ) { | | |
| Management Message Type=52 | 8 bits | |
| N_Recommended | 8 bits | |
| For (j=0;j< N_NEIGHBORS;J++){ | | |
| Neighbor BS-ID | 48 bits | |
| BS S/(N+1) | 8 bits | |
| Service level prediction | 8 bits | |
| } | | |
| } | | |

As illustrated in Table 12, the MOB_MSSHO_REQ message includes a plurality of IEs, that is, the ‘Management Message Type’ representing the type of transmitted message, and the ‘N_Recommended’ representing a result obtained by a scanning of a mobile subscriber station. Herein, as illustratedin Table 12, the ‘N_Recommended’ contains the identifiers of neighbor base stations, a CINR of a pilot channel signal for each of the neighbor base stations, and the level of a service predicted to be provided from the neighbor base stations to the mobile subscriber station.

Meanwhile, when the serving base station 1040 receives the MOB_MSSHO_REQ message transmitted from the mobile subscriber station 1000, the serving base station 1040 understands information on a list of target base stations to which the mobile subscriber station 1000 can hand over from the ‘N_Recommended’ information of the received MOB_MSSHO_REQ message in step 1023. In steps 1025 and 1027, the serving base station 1040 transmits handover notifications (‘HO_notifications’) message to neighbor base stations contained in the list of target base stations to which the mobile subscriber station 1000 can handover. Herein, for convenience of description, the neighbor base stations contained in the list of target base stations to which the mobile subscriber station 1000 can handover will be called a first target base station(TARGET BS#1) 1060 and a second target base station(TARGET BS#2) 1080. Table 13 illustrates the structure of the HO_notification message transmitted from the serving base station 1040 to the target base stations to which the mobile subscriber station 1000 can handover.

TABLE 13

| Syntax | Size | Notes |
|---|---|---|
| Global Header | 152-bit | |
| For (j=0;j< Num Records;J++){ | | |
| MSS unique identifier | 48-bit | 48-bit unique identifier used by MSS |
| | | (as provided by the MSS or by the I- |
| | | am-host-of message) |
| Estimated Time to HO | 16-bit | In milliseconds, relative to the time |
| | | stamp, value 0 of this parameter |
| | | indicates that no actual HO is |
| | | pending |
| Required BW | 8-bit | Bandwidth which is required by |
| | | MSS (to guarantee minimum packet |
| | | data transmission) |
| Required QoS | 8-bit | Name of Service Class representing |
| | | Authorized QoSparamSet |
| } | | |
| Security field | TBD | A means to authenticate this |
| | | message |
| CRC field | 32-bit | IEEE CRC-32 |

As illustrated in Table 13, the HO_notification message includes a plurality of IEs, that is, an identifier MSS ID of the mobile subscriber station 1000 intending to perform a handover procedure to the first target base station 1060 or the second target base station 1080, an estimated start time of a handover by the mobile subscriber station 1000, and information on a bandwidth requested from the mobile subscriber station 1000 to a target base station to be a new serving base station, and the level of a service to be provided to the mobile subscriber station 1000. Herein, the bandwidth and the service level requested by the mobile subscriber station 1000 are identical to the predicted service level information recorded in the MOB_MSSHO-REQ message described in Table 12.

Meanwhile, when the first target base station 1060 or the second target base station 1080 receive the HO_notification messages from the serving base station 1040, they transmit handover notification response (‘notification_response’) messages, response messages with respect to the HO_notification message, to the serving base station 1040 in steps 1029 and 1031. Table 14 illustrates the structure of the HO_notification_response message.

TABLE 14

| Syntax | Size | Notes |
|---|---|---|
| Global Header | 152-bit | |
| For (j=0;j< Num Records;J++){ | | |
| MSS unique identifier | 48-bit | 48-bit unique identifier used by MSS |
| | | (as provided by the MSS or by the I- |
| | | am-host-of message) |
| QoS Estimated | 8-bit | Bandwidth which is provided by |
| | | BS(to guarantee minimum packet |
| | | data transmission)TBD how to set |
| | | this field |
| BW Estimated | 8-bit | Quality of Service level |
| | | Unsolicited Grant Service (UGS) |
| | | Real-time Polling Service (rtPS) |
| | | Non-Real-time Polling Service |
| | | nrtPS) |
| | | Best Effort |
| ACK/NACK | 1-bit | Acknowledgement or Negative |
| | | acknowledgement |
| | | 1 is Acknowledgement which |
| | | means that the neighbor BS accepts |
| | | the HO_notification message from |
| | | the serving BS |
| | | 0 is Negative Acknowledgement |
| | | which means that the neighbor BS |
| | | may not accept the HO_notification |
| | | message from the serving BS |
| } | | |
| Security field | TBD | A means to authenticate this |
| | | message |
| CRC field | 32-bit | IEEE CRC-32 |

As illustrated in Table 14, the HO_notification response message includes a plurality of IEs, that is, an identifier MSS ID of a mobile subscriber station intending to perform a handover procedure to target base stations, a response ACK/NACK regarding whether or not the target base stations can approve the handover request of the mobile subscriber station, and bandwidth and service level information capable of being provided by each target base station when the mobile subscriber station hands over to each target base station.

Meanwhile, when the serving base station 1040 receives the HO_notification_response messages transmitted from the first target base station 1060 and the second target base station 1080, the serving base station 1040 selects a target base station, which can optimally provide a bandwidth and a service level requested by the mobile subscriber station 1000 when the mobile subscriber station 1000 hands over. For instance, in step 1029, the first target base station 1060 transmits a HO_notification_response containing information signifying that the first target base station 1060 can provide the mobile subscriber station 1000 with a lower service level than it is currently receiving. Further, in step 1031, the second target base station 1080 transmits a HO_notification_response containing information signifying that the second target base station 1080 can provide the mobile subscriber station 1000 with the same service level as it is currently receiving. Next, in step 1033, the serving base station 1040 selects the second target base station 1080 capable of providing the same service level, and transmits a handover notification confirmation (‘HO_notification_confirm’) message as a response for the HO_notification_response message of the selected second target base station 1080. Table 15 illustrates the structure of the HO_notification_confirm message transmitted to the selected target base station.

TABLE 15

| Syntax | Size | Notes |
|---|---|---|
| Global Header | 152-bit | |
| For (j=0;j< Num Records;J++){ | | |
| MSS unique identifier | 48-bit | 48-bit universal MAC address of the |
| | | MSS (as provided to the BS on the |
| | | RNG-REQ message) |
| QoS Estimated | 8-bit | Bandwidth which is provided by |
| | | BS(to guarantee minimum packet |
| | | data transmission)TBD how to set |
| | | this field |
| BW Estimated | 8-bit | Quality of Service level |
| | | Unsolicited Grant Service (UGS) |
| | | Real-time Polling Service (rtPS) |
| | | Non-Real-time Polling Service |
| | | (nrtPS) |
| | | Best Effort |
| } | | |
| Security field | TBD | A means to authenticate this |
| | | message |
| CRC field | 32-bit | IEEE CRC-32 |

As illustrated in Table 15, the HO_notification_confirm message includes a plurality of IEs, that is, an identifier MSS ID of a mobile subscriber station intending to perform a handover procedure to a selected target base station, and bandwidth and service level information capable of being provided by the selected target base station when the mobile subscriber station hands over to the selected target base station.

Also, after selecting the target base station, the serving base station 1040 transmits a mobile subscriber station handover response (‘MOB_HO_RSP’) message, a response message with respect to the MOB_MSSHO_REQ message, to the mobile subscriber station 1000 in step 1035. Herein, the MOB_HO_RSP message contains information on a target base station to which the mobile subscriber station 1000 hands over. Table 16 illustrates the structure of the MOB_HO_RSP message.

TABLE 16

| Syntax | Size | Notes |
|---|---|---|
| MOB_HO_RSP_message_Format( ) { | | |
| Management Message Type=53 | 8 bits | |
| Estimated HO time | 8 bits | |
| N_Recommended | 8 bits | |
| For (j=0;j< N_NEIGHBORS;J++){ | | |
| Neighbor BS-ID | 48 bits | |
| Service level prediction | 8 bits | This parameter exists only |
| | | when the message is sent by |
| | | the BS |
| } | | |
| } | | |

As illustrated in Table 16, the MOB_HO_RSP message includes a plurality of IEs, that is, the ‘Management Message Type’ representing the type of transmitted message, an estimated start time of a handover procedure, and the ‘N_Recommended’ representing a result for target base stations selected by a serving base station. Herein, as shown in Table 16, the ‘N_Recommended’ contains identifiers of the selected target base stations and the level of a service predicted to be provided from each target base station to a mobile subscriber station. In FIG. 10, the MOB_HO_RSP message finally includes only target base station information on the second target base station 1080 from among target base stations contained in the handover-executable target base station list. However, when there exists a plurality of target base stations capable of providing bandwidth and service level requested by the mobile subscriber station 1000 from among the target base stations contained in the handover-executable target base station list, the MOB_HO_RSP message may include information on the plurality of target base stations.

Next, after receiving the MOB_HO_RSP message, the mobile subscriber station 1000 selects a target base station to which the mobile subscriber station 1000 hands over by means of the ‘N_Recommended’ information contained in the MOB_HO_RSP message transmitted from the serving base station 1040. After selecting the target base station, the mobile subscriber station 1000 transmits a mobile subscriber station handover indication (‘MOB_HO_IND’) message, a response message with respect to the MOB_HO_RSP message, to the serving base station 1040 in step 1037. Table 17 illustrates the structure of the MOB_HO_IND message.

TABLE 17

| Syntax | Size | Notes |
|---|---|---|
| MOB_HO_IND_message_Format( ) { | | |
| Management Message Type=54 | 8 bits | |
| TLV Encoded Information | Variable | TLV specific |
| Target_BS_ID | 48 bits | |
| } | | |

As illustrated in Table 17, the MOB_HO_‘ND message includes a plurality of IEs, that is, the ‘Management Message Type’ representing the type of transmitted message, the ‘Target_BS_ID’ representing an identifier of a target base station selected by a mobile subscriber station, and the ‘TLV Encoded Information’ representing extra information in addition to the information.

After receiving the MOB_HO_IND message, the serving base station 1040 recognizes that the mobile subscriber station 1000 hands over to the target base station (i.e., the second target base station 1080) contained in the MOB_HO_IND message, and then releases a link with the mobile subscriber station 1000, in step 1039.

After the link with the serving base station 1040 has been released in this way, the mobile subscriber station 1000 performs a handover procedure to the selected target base station.

FIG. 11 is a signal flowchart schematically illustrating a handover process by the request of the serving base station in the conventional broadband wireless access communication system employing an OFDM/OFDMA scheme, and in particular, FIG. 11 schematically illustrates the handover process of the mobile subscriber station by the request of the serving base station in the IEEE 802.16e communication system.

In FIG. 11, a case in which the serving base station requests a handover of the mobile subscriber station belonging to the serving base station may occur when the base station is overloaded and requires a load sharing for dispersing the load of the base station, or the base station copes with the change of the uplink status of a mobile subscriber station.

Referring to FIG. 11, first, a serving base station 1140 transmits a MOB_NBR_ADV message to a mobile subscriber station 1100 in step 1111. Then, the mobile subscriber station 1100 receives the MOB_NBR_ADV message and obtains information on neighbor base stations. Further, in step 1113, the mobile subscriber station 1100 transmits a MOB_SCN_REQ message to the serving base station 1140 when the mobile subscriber station 1100 intends to scan the CINRs of pilot channel signals transmitted from the neighbor base stations. Herein, since a timing point at which the mobile subscriber station 1100 requests a scanning has no direct relation to a scanning operation for the CINR of the pilot channel signal, a detailed description about the time point will be omitted. In step 1115, the serving base station 1140 having received the MOB_SCN_REQ message transmits the MOB_SCN_RSP message, which contains information to be scanned by the mobile subscriber station 1100, to the mobile subscriber station 1100. In step 1117, the mobile subscriber station 1100 having received the MOB_SCN_RSP message containing the scanning information performs a CINR scanning of pilot channel signals with respect to neighbor base stations, which have been recognized through the reception of the MOB_NBR_ADV message, according to parameters (i.e., scan duration) contained in the MOB_SCN_RSP message.

When the mobile subscriber station 1100 belonging to the serving base station 1140 intends to move to a new base station different from the serving base station 1140, the serving base station 1140 starts a process for releasing a link with the mobile subscriber station 1100 in step 1119. The serving base station 1140 transmits the HO_notification messages as shown in Table 13 to neighbor base stations in steps 1121 and 1123. Herein, for convenience of description, the neighbor base stations receive the HO_notification messages transmitted from the serving base station 1140 will be called a first target base station 1160 and a second target base station 1180. Further, the HO_notification message contains information on a bandwidth and a service level which must be provided by a target base station to be a new serving base station of the mobile subscriber station 1100.

In steps 1125 and 1127, the first target base station 1160 and the second target base station 1180, having received the HO_notification messages, transmit HO_notification_response messages, response messages for the HO_notification messages, to the serving base station 1140. The HO_notification_response message transmitted in steps 1125 or 1127 contains a response ACK/NACK regarding whether or not the target base stations can perform a handover procedure requested by the serving base station 1140, and bandwidth and service level information capable of being provided to the mobile subscriber station 1100, as shown in Table 14.

Next, after receiving the HO_notification_response messages from the first target base station 1160 and the second target base station 1180, the serving base station 1140 selects target base stations capable of providing the bandwidth and the service level requested by the mobile subscriber station 1100. For instance, in step 1125, the first target base station 1160 transmits a HO_notification_response containing information signifying that the first target base station 1160 can provide the mobile subscriber station 1100 with a lower service level than it is currently receiving. Further, in step 1127, the second target base station 1180 transmits a HO_notification_response containing information signifying that the second target base station 1180 can provide the mobile subscriber station 1100 with the same service level as it is currently receiving. Next, in step 1129, the serving base station 1140 selects the second target base station 1180 capable of providing the same service level and transmits a HO_notification_confirm message as a response for the HO_notification_response message of the selected second target base station 1180.

After selecting the target base station as described above, the serving base station 1140 transmits a MOB_HO_RSP message to the mobile subscriber station 1100 in step 1131. The MOB_HO_RSP message contains N_Recommended information selected by the serving base station 1140, that is, information on a bandwidth and a service level capable of being provided from the selected target base station and the target base stations to the mobile subscriber station 1100.

The mobile subscriber station 1100 having received the MOB_HO_RSP message recognizes that a handover has been requested by the serving base station 1140, and selects a target base station to which the mobile subscriber station 1100 may hand over with reference to the N_Recommended information contained in the MOB_HO_RSP message. After selecting the target base station, the mobile subscriber station 1100 transmits a MOB_HO_IND message, a response message for the MOB_HO_RSP message, to the serving base station 1140 in step 1133.

After receiving the MOB_HO_IND message, the serving base station 1140 recognizes that the mobile subscriber station 1100 may hand over to the target base station contained in the MOB_HO_IND message, and then releases a link with the mobile subscriber station 1100, in step 1135.

After the link with the serving base station 1140 is released in this way, the mobile subscriber station 1100 starts a handover procedure to the selected target base station.

The above description relates to the sleep mode operation and the handover mode operation having been proposed for the IEEE 802.16e communication system. Herein, the sleep mode operation and the handover mode operation are performed according to respective purposes as described above, and correlation does not exist between the two operations. That is, asleep mode operation scheme is a scheme for minimizing the power consumption of a subscriber station and has been independently proposed without relation to handover. Further, handover is a scheme for ensuring the mobility and the QoS of the subscriber station and has been separately proposed without relation to the sleep mode operation scheme.

However, it is preferred that the two operation schemes be simultaneously considered according to circumstances in a broadband wireless access communication system, because power consumption of a mobile subscriber station must be minimized and the mobility of the mobile subscriber station must be ensured in an IEEE 802.16e communication system.

When the two operation schemes are simultaneously used, the following problems occur due to the autonomy of the two operation schemes.

1) When the mobile subscriber station must move into a neighbor cell, a handover process must necessarily accompany it. That is, when a handover occurs during data communication of the mobile subscriber station, the handover process must be quickly completed, that is, the handover process must be completed within as short a time as possible. However, when a state-transition to a sleep mode during the handover process presently occurs, the handover process is further delayed and QoS of data traffic cannot be ensured. Accordingly, during the handover process, an additional operation and an algorithm for the additional operation are inevitably necessary in enabling the mobile subscriber station to continuously maintain an awake state.

2) The mobile subscriber station having been in the sleep mode state awaken in an awake state for a short interval during a listening interval, receives a traffic indication message, and confirms whether or not data from a base station exists and a connection ID of the mobile subscriber station exists. Herein, when the connection ID does not exist, the mobile subscriber station returns to a sleep mode, increases an existing sleep interval by twice, and stays in the sleep mode state.

Further, when the mobile subscriber station has moved into a cell controlled by a neighbor base station, the mobile subscriber station does not recognize the movement to the cell and awaken in an awake mode state again for a short interval in order to confirm whether or not data from an existing base station (i.e., serving base station) exists during a listening interval after a sleep interval. Then, the mobile subscriber station tries a synchronization to the downlink signal of the existing base station.

However, since the mobile subscriber station has already moved into the neighbor cell using another frequency band, all configuration information and a data traffic connection with the existing base station having provided a service are regarded as invalid information. Accordingly, the mobile subscriber station must perform an initial process with the neighbor base station again. Further, since the mobile subscriber station has moved into the neighbor cell without a normal handover process, the existing base station having provided the service recognizes that the mobile subscriber station still stays in a cell controlled by the base station. Therefore, disagreement of status information occurs.

Accordingly, even though a handover does not occur during a listening interval, when there is a possibility that a handover occurs later during a sleep interval, an additional condition and operation, and an algorithm for the additional condition and operation for maintaining an awake state are inevitably necessary.

Consequently, although the problems as described above occur, there is no proper operation procedure considering both a sleep mode operation scheme and a handover mode operation scheme.

### SUMMARY OF THE INVENTION

Accordingly, the present invention has been made to solve the above-mentioned problems occurring in the prior art and it is an object of the present invention to provide a mode-transition method considering a handover, in which a subscriber station checks a CINR of a serving base station, determines whether or not a channel state is favorable, and then transits to an awake mode or a sleep mode according to the result of the determination, when the subscriber station in the sleep mode moves in a broadband wireless access communication system.

It is another object of the present invention to provide a method by which a subscriber station denies a state-transition request to a sleep mode by a base station when the subscriber station enters a handover process in an awake mode while simultaneously considering a handover operation scheme.

It is a further another object of the present invention to provide a control method and an operation method which enables a subscriber station to stay in an awake mode after a listening interval and perform a handover process in order to prevent the subscriber station in a sleep mode from moving into a neighbor base station without a handover process.

In order to accomplish the aforementioned objects, according to one aspect of the present invention, there is provided a method for enabling a subscriber station to shift from a sleep mode to an awake mode in a broadband wireless access communication system including the sleep mode in which there exists no data to be transmitted between the subscriber station and a base station, and the awake mode in which there exists data to be exchanged between the subscriber station and the base station, the method including the steps of measuring a signal-to-noise ratio (SNR) with respect to the base station in a time interval for monitoring a received signal during the sleep mode; and shifting from the sleep mode to the awake mode when the measured signal-to-noise ratio is less than a first threshold value set in advance.

In order to accomplish the aforementioned objects, according to one aspect of the present invention, there is provided a method for enabling a subscriber station to maintain an awake mode in a broadband wireless access communication system including a sleep mode in which there exists no data to be transmitted between the subscriber station and a base station, and the awake mode in which there exists data to be exchanged between the subscriber station and the base station, the method the steps of measuring a signal-to-noise ratio with respect to the base station; and setting a state of the subscriber station to be an awake mode lock state to maintain the awake mode when the measured signal-to-noise ratio is less than a first threshold value set in advance.

### BRIEF DESCRIPTION OF THE DRAWINGS

The above and other objects, features and advantages of the present invention will be more apparent from the following detailed description taken in conjunction with the accompanying drawings, in which:

FIG. 1 is a structure diagram schematically illustrating a structure of a broadband wireless access communication system employing an OFDM/OFDMA scheme;

FIG. 2 is a diagram schematically illustrating a current sleep mode operation proposed for an IEEE 802.16e communication system;

FIG. 3 is a signal flowchart illustrating a state-transition process to a sleep mode of a mobile subscriber station according to request of the mobile subscriber station, which has been proposed for an IEEE 802.16e communication system;

FIG. 4 is a signal flowchart illustrating a state-transition process to a sleep mode of a mobile subscriber station under control of a base station, which has been proposed for an IEEE 802.16e communication system;

FIG. 5 is a signal flowchart illustrating a state-transition process to an awake mode of a mobile subscriber station under control of a base station, which has been proposed for an IEEE 802.16e communication system;

FIG. 6 is a diagram schematically illustrating a structure of a downlink frame of a broadband wireless access communication system employing an OFDM/OFDMA scheme;

FIG. 7 is a diagram schematically illustrating the structure of an uplink frame of a broadband wireless access communication system employing an OFDM/OFDMA scheme;

FIG. 8 is a signal flowchartillustrating a ranging process between a subscriber station and a base station in a broadband wireless access communication system employing an OFDM scheme;

FIG. 9 is a structure diagram schematically illustrating a structure of a broadband wireless access communication system supporting a handover and employing an OFDM/OFDMA scheme;

FIG. 10 is a signal flowchart illustrating a handover request process by a mobile subscriber station in a broadband wireless access communication system supporting a handover and employing an OFDM/OFDMA scheme;

FIG. 11 is a flowdiagram illustrating a handover request process by a serving base station in a broadband wireless access communication system supporting a handover and employing an OFDM/OFDMA scheme;

FIG. 12 is a diagram illustrating a handover process of a mobile subscriber station according to a CINR value measured during a listening interval according to an embodiment of the present invention;

FIG. 13 is a diagram illustrating a process by which a mobile subscriber station transits to an awake mode according to a CINR value measured during a listening interval for a handover according to an embodiment of the present invention;

FIG. 14 is a diagram illustrating a process by which a mobile subscriber station transits to an awake mode in consideration of a handover as the conventional sleep mode operation according to an embodiment of the present invention;

FIG. 15 is a flowchart illustrating a process by which a mobile subscriber station in a sleep mode transits to an awake mode by a CINR measured during a listening interval in consideration of a handover according to an embodiment of the present invention;

FIG. 16 is a diagram illustrating a handover process of a mobile subscriber station in an awake mode according to a periodically measured CINR value according to an embodiment of the present invention;

FIG. 17 is a diagram illustrating a process by which a mobile subscriber station is locked in an awake mode for a handover according to a CINR measured during a listening interval in an IEEE 802.16e communication system according to an embodiment of the present invention;

FIG. 18 is a diagram illustrating a process by which a mobile subscriber station transits to a sleep mode in consideration of a handover as the conventional sleep mode operation according to an embodiment of the present invention;

FIG. 19 is a flowchart illustrating a process according to an embodiment of the present invention, which enables a mobile subscriber station in an awake mode to transit to a sleep mode considering a handover in a state change for a sleep mode transition;

FIG. 20 is a flowchart illustrating a process according to an embodiment of the present invention, which enables a mobile subscriber station in an awake mode to transit to a sleep mode considering a handover in a state change for a sleep mode transition;

FIG. 21 is a flowchart illustrating a procedure according to an embodiment of the present invention, which enables a mobile subscriber station in a sleep mode to transit to an awake mode in consideration of a handover including a normal state restoration according to a repetition detection;

FIG. 22 is a flowchart illustrating a procedure according to an embodiment of the present invention, which enables a mobile subscriber station in an awake mode to transit to a sleep mode in a state change for a sleep mode transition in consideration of a handover including a normal state restoration according to a repetition detection;

FIG. 23 is a flowchart illustrating a procedure according to an embodiment of the present invention, which enables a mobile subscriber station in an awake mode to transit to a sleep mode in a state change for a sleep mode transition in consideration of a handover including a normal state restoration according to a repetition detection;

FIG. 24 is a signal flowchart illustrating a process by which a mobile subscriber station in a sleep mode transits to an awake mode without control of a base station according to an embodiment of the present invention;

FIG. 25 is a signal flowchart illustrating a process by which a mobile subscriber station in an awake mode reports the setting of the awake mode and sets the awake mode according to an embodiment of the present invention;

FIG. 26 is a signal flowchart illustrating a process by which a mobile subscriber station denies a transition to a sleep mode by a control of a base station and stays in an awake mode according to an embodiment of the present invention;

FIG. 27 is a diagram illustrating a process by which a mobile subscriber station in an awake mode denies a transition to a sleep mode by a control of a base station and stays in an awake mode when the mobile subscriber station is locked in the awake mode according to a periodically measured CINR value according to an embodiment of the present invention; and

FIG. 28 is a diagram illustrating a process by which a mobile subscriber station in an awake mode transits to a sleep mode according to a periodically measured CINR value when the mobile subscriber station transits to the sleep mode by a control of a base station, according to an embodiment of the present invention.

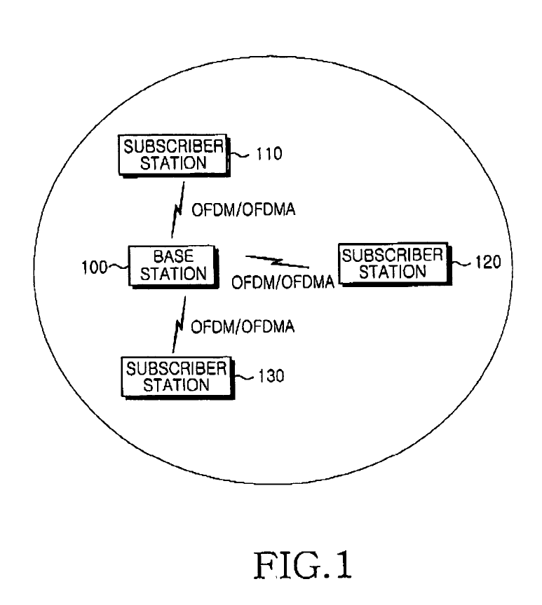

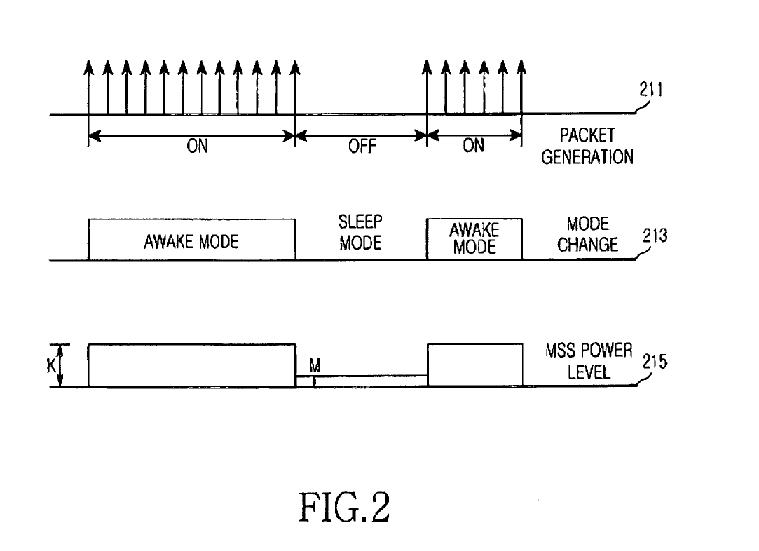

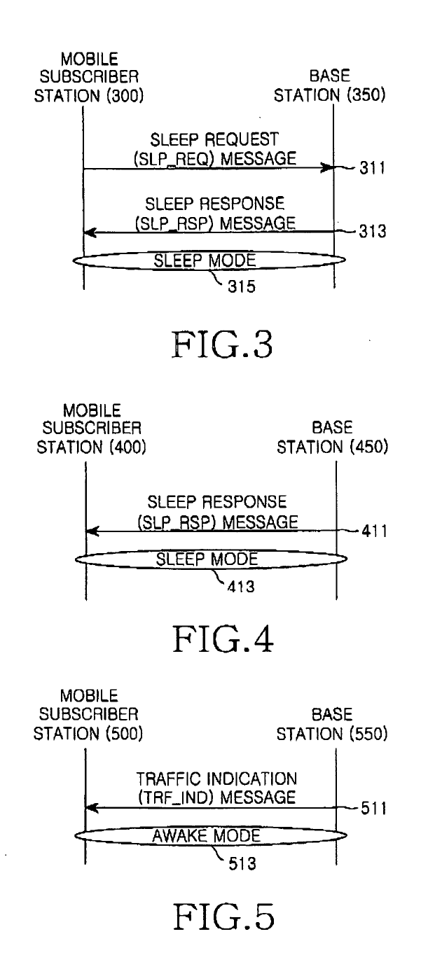

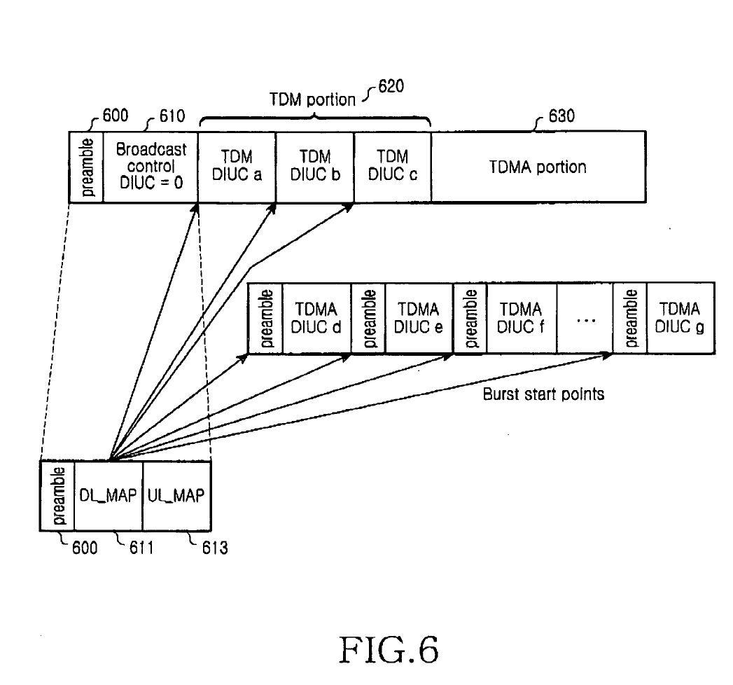

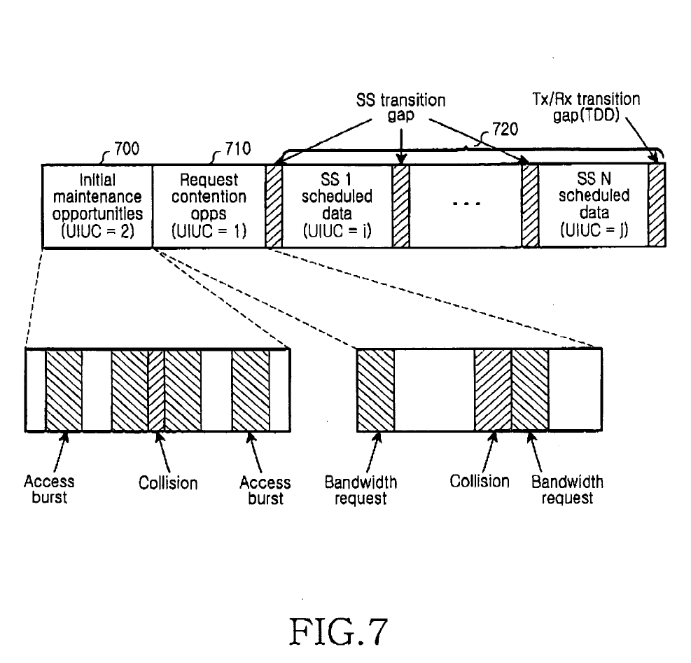

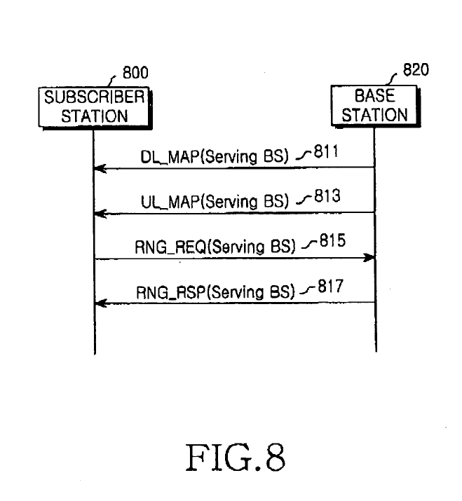

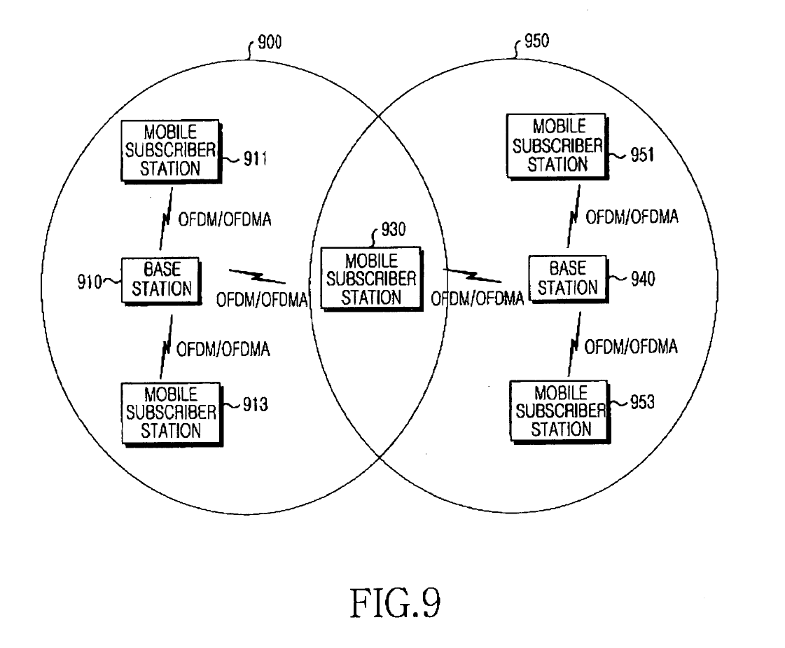

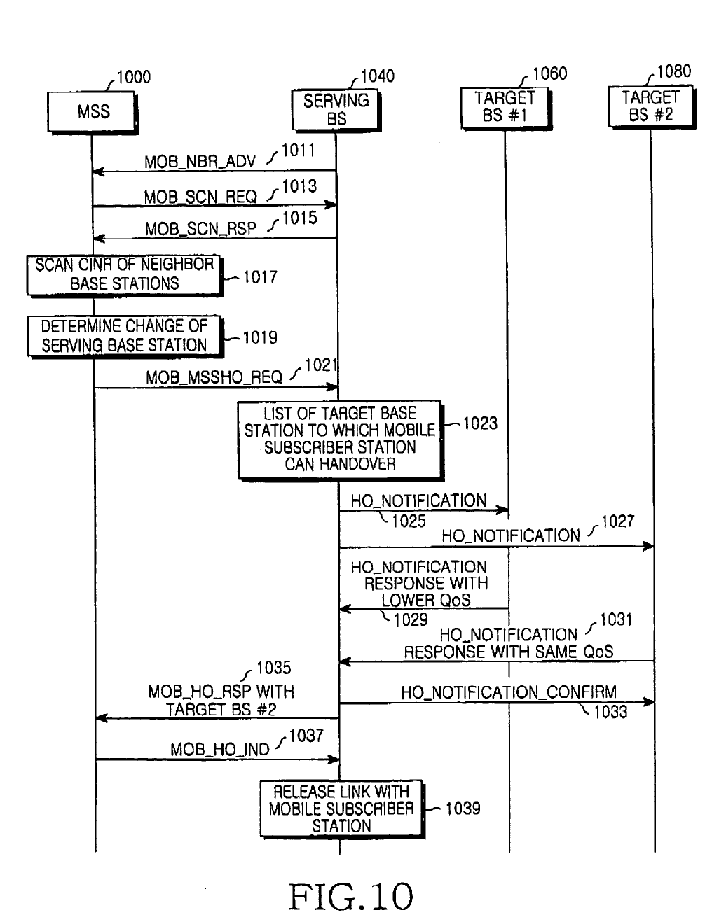

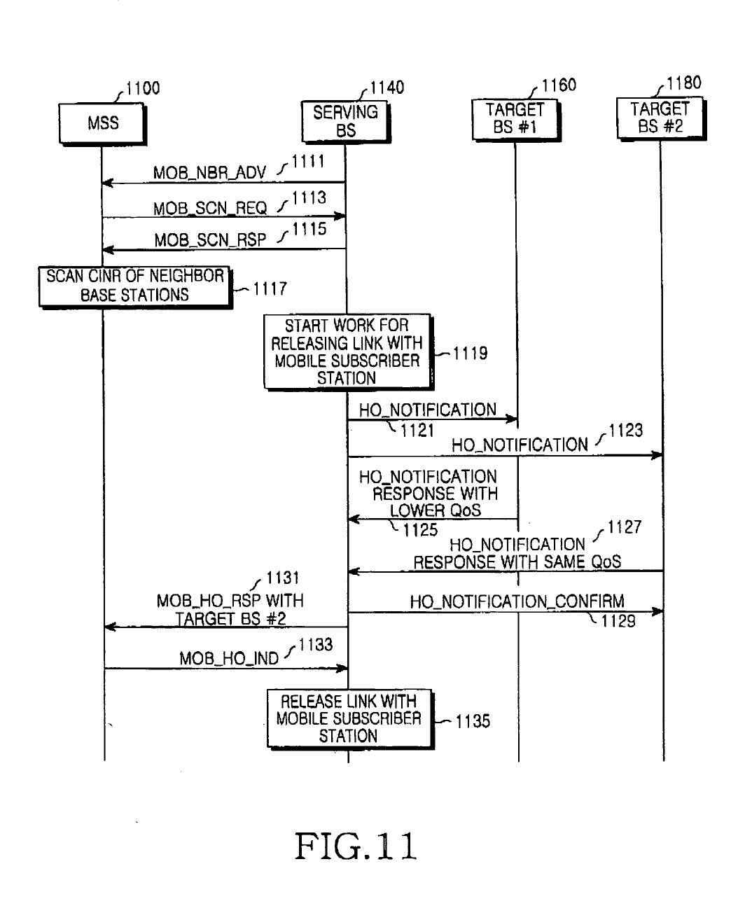

### DETAILED DESCRIPTION OF THE PREFERRED EMBODIMENT

Hereinafter, preferred embodiments according to the present invention will be described with reference to the accompanying drawings. In the following description of the present invention, a detailed description of known functions and configurations incorporated herein will be omitted when it may make the subject matter of the present invention unclear.

Conventionally, since an IEEE(Institute of Electrical and Electronics Engineers) 802.16e communication system must consider the mobility of a mobile subscriber station(MSS) in an IEEE 802.16a communication system, the power consumption of a mobile subscriber station becomes an important factor of an entire system. Accordingly, a sleep mode operation between a mobile subscriber station and a base station and an awake mode operation corresponding to the sleep mode operation have been proposed to minimize the power consumption of the mobile subscriber station. However, the sleep mode operation and the awake mode operation having been proposed for the IEEE 802.16e communication system up to now shows a plurality of problems as described in the prior art when the sleep mode operation and the awake mode operation are performed in relation to a handover process. Accordingly, the present invention proposes a handover operation in the following cases in order to solve the problems of the prior art.

1. The application of a handover operation for a mobile subscriber station in a sleep mode state; and

2. The application of a handover operation for a mobile subscriber station in an awake mode state.

Before describing methods according to the present invention, parameters necessary in achieving the methods in the present invention are newly defined as follows.

Table 18 illustrates the parameters proposed according to the present invention.

TABLE 18

| Parameters | Description |
|---|---|
| AWAKE_{—} | carrier to interference and noise ratio |
| THRESHOLD | (’CINR’) critical value used as |
| | determination condition for maintenance |
| | of awake state of mobile subscriber |
| | station |
| AWAKE_CNT | Represents Count value which increases |
| | by 1 when measured CINR value is less |
| | than AWAKE_THRESHOLD value, and it is |
| | set to 0 when measured CINR value is |
| | greater than AWAKE_THRESHOLD value, |
| | or NORMAL_CNT is greater than/equal |
| | to MAX_NORMAL_CNT |
| MAX_AWAKE_CNT | The mobile subscriber station sets |
| | awake mode lock and maintains awake |
| | mode state when AWAKE_CNT |
| | is equal to/greater than |
| | MAX_AWAKE_CNT |
| DURATION_FOR_{—} | Represents time period for which a case |
| AWAKE | in which measured CINR value is less |
| | than AWAKE_THRESHOLD value is |
| | continued, and the time period is set |
| | to 0 when measured CINR value is |
| | greater than |
| | MAX_DURATION_FOR_AWAKE |
| MAX_DURATION_{—} | When DURATION_FOR_AWAKE value is |
| FOR_AWAKE | equal to/greater than |
| | MAX_DURATION_FOR_AWAKE, |
| | the mobile subscriber station sets |
| | awake mode lock and maintains awake |
| | mode state |
| NORMAL_CNT | Represents Count value which increases |
| | by 1 when measured CINR value is |
| | greater than/equal to |
| | AWAKE_THRESHOLD value, and |
| | it is set to 0 when measured CINR value |
| | is less than AWAKE_THRESHOLD value |
| MAX_NORMAL_CNT | When NORMAL_CNT is equal to/greater than |
| | MAX_NORMAL_CNT value, the mobile |
| | subscriber station releases awake |
| | mode lock and returns to normal state |
| DURATION_FOR_{—} | Represents time period for which a case |
| NORMAL | in which measured CINR value is greater |
| | than/equal to AWAKE_THRESHOLD |
| | value is continued, and the time |
| | period is set to 0 when measured |
| | CINR value is greater than |
| | MAX_DURATION_FOR_NORMAL |
| MAX_DURATION_{—} | When DURATION_FOR_NORMAL |
| FOR_NORMAL | value is equal to/greater than |
| | MAX_DURATION_FOR_NORMAL, |
| | the mobile subscriber station releases |
| | awake mode lock and returns to normal |
| | state |
| HO_THRESHOLD | CINR critical value at which mobile |
| | subscriber station must perform |
| | handover process |

Referring to Table 18, the parameters proposed in the present invention are an AWAKE_threshold, an AWAKE_CNT, a MAX_AWAKE_CNT, a NORMAL_CNT, a MAX_NORMAL_CNT, an HO_THRESHOLD, a DURATION_FOR_AWAKE, a MAX_DURATION_FOR_AWAKE, a DURATION_FOR_NORMAL, and a MAX_DURATION_FOR_NORMAL.

The AWAKE_threshold value is a CINR critical value, based on which maintenance of an awake state of a subscriber station is determined. Herein, if the CINR of a serving base station currently having provided a service is maintained to have a value less than the AWAKE_threshold for a predetermined number of times or a predetermined time period, the subscriber station determines that it is difficult to continuously communicate with the serving base station. Accordingly, since there is a possibility that the mobile subscriber station will perform a handover procedure within a short time, it is necessary to enable the mobile subscriber station to maintain an awake mode.

That is, when the CINR of the serving base station is less than the AWAKE_threshold, the AWAKE_CNT value increases by 1. In contrast, when the CINR of the serving base station is greater than the AWAKE_threshold, the AWAKE_CNT value is set to 0 again. Meanwhile, even when the NORMAL_CNT is greater than/equal to the MAX_NORMAL_CNT, the AWAKE_CNT value is set to 0.

Herein, when the CINR of the serving base station is continuously less than the AWAKE_threshold and thus the AWAKE_CNT value continuously increases, the channel status between the serving base station and the mobile subscriber station becomes degraded. Therefore, a possibility of a handover occuring becomes stronger. Accordingly, when the AWAKE_CNT value increases and reaches a predetermined MAX_AWAKE_CNT value, the mobile subscriber station is set to be locked in the awake mode and then continuously maintains the awake mode state.

In this way, although the mobile subscriber station stays in a sleep mode, when the channel status with the serving base station continuously degrades and thus satisfies the aforementioned conditions, the mobile subscriber station is locked in the awake mode so that the mobile subscriber station can perform a handover at any time. In the present invention, a state continuously maintaining the awake mode according to these conditions will be called an ‘awake mode lock’.

Meanwhile, when the channel status between the serving base station and the mobile subscriber station grows better even though the mobile subscriber station stays in the awake mode lock state, it is preferred to release the awake mode lock and reduce power waste according to a normal sleep mode.

The two parameters (i.e., the NORMAL_CNT and the MAX_NORMAL_CNT) are used as a condition for releasing the awake mode lock state. When the CINR value of the serving base station is greater or equal than the AWAKE_threshold value, the NORMAL_CNT is counted and thus the NORMAL_CNT value is increased. Accordingly, when the NORMAL_CNT value increases in the awake mode lock state, the channel status between the serving base station and the mobile subscriber station grows better, thereby reducing the possibility of a handover of the mobile subscriber station. Accordingly, when the NORMAL_CNT value increases and reaches a predetermined reference value, that is, the MAX_NORMAL_CNT value, the mobile subscriber station determines that the possibility of a handover is slim, and releases the awake mode lock state. When the awake mode lock state is released in this way, a sleep mode and an awake mode are set according to a normal procedure.

Further, the aforementioned method uses the AWAKE_CNT, the MAX_AWAKE_CNT, the NORMAL_CNT, and the MAX_NORMAL_CNT as a criterion for a transition to an awake mode. Herein, another embodiment of the present invention proposes another method which is similar to the method above but uses a time period concept instead of the aforementioned count values.

That is, when the DURATION_FOR_AWAKE, for which the CINR of the serving base station is maintained at a value less than the AWAKE_threshold, is grater than or equal to the predetermined MAX_DURATION_FOR_AWAKE,the mobile subscriber station is set to be locked in the awake mode and then continuously maintains the awake mode state. Herein, the channel status between the serving base station and the mobile subscriber station becomes degraded, thereby increasing the possibility of a handover of the mobile subscriber station. Since an operation after this process is the same as that of the aforementioned method, a detailed description is omitted here.

Herein, the two parameters (i.e., the DURATION_FOR_NORMAL and the MAX_DURATION_FOR_NORMAL) are used as a condition for releasing the awake mode lock state. The DURATION_FOR_NORMAL represents a time period for which the CINR of the serving base station is maintained at a value greater than the AWAKE_threshold. Herein, when the DURATION_FOR_NORMAL value continuously increases and reaches the MAX_DURATION_FOR_NORMAL value, the mobile subscriber station determines that the possibility of a handover is slim, and releases the awake mode lock state. When the awake mode lock state is released in this way, a sleep mode and an awake mode are set according to a normal procedure. Since an operation after this process is the same as that of the aforementioned method, a detailed description is omitted here.

As described above, the present invention employs the method using the DURATION_FOR_AWAKE instead of the AWAKE_CNT, the MAX_DURATION_FOR_AWAKE instead of the MAX_AWAKE_CNT, the DURATION_FOR_NORMAL instead of the NORMAL_CNT, and the MAX_DURATION_FOR_NORMAL instead of the MAX_NORMAL_CNT. That is, the method uses a passage of time concept instead of a count value concept. Further, since an operation using the passage of time is the same as that using the count value, a further detailed description is omitted here. Accordingly, operations which will be described below use the aforementioned AWAKE_CNT, MAX_AWAKE_CNT, NORMAL_CNT, and MAX_NORMAL_CNT, but the scope of the present invention is not limited to these parameters.

A more detailed description of the present invention by the newly added parameters will be given later.

Hereinafter, a handover procedure in a sleep mode and a handover procedure in an awake mode according to the present invention will be described.

1) The Handover Procedure in the Sleep Mode

In the conventional sleep mode operation, when a listening interval arrives, the mobile subscriber station in a sleep state awaken in a awake state for a short interval during the listening interval and waits for reception of a traffic indication(TRF_IND) message signifying whether or not there exists data to be transmitted from the base station to the mobile subscriber station. When the mobile subscriber station has not received the traffic indication message during the listening interval, or a connection ID representing the corresponding mobile subscriber station does not exist in the received traffic indication message even though the subscriber station has received the traffic indication message, the mobile subscriber station returns to the sleep state again.

Meanwhile, when there is a possibility that the mobile subscriber station will hand over to a neighbor cell controlled by a neighbor base station in a state in which the subscriber station has transited to a sleep mode, it is preferred that the subscriber station can quickly hand over to the neighbor cell through a handover process without returning to the sleep mode according to the present invention.

For this purpose, in the present invention, when there exists no data to be received from the base station during the listening interval of the conventional sleep mode operation, that is, the mobile subscriber station has not received the traffic indication message, or a connection ID representing the base station does not exist in the received traffic indication message even though the mobile subscriber station has received the traffic indication message, the mobile subscriber station determines whether or not a handover situation occurs without returning to the sleep state again.

Herein, in the determination of the handover situation, when a handover must be performed because the level of a CINR value is less than that of the HO_THRESHOLD in Table 18 from the result of measurement of the CINR value representing the intensity of a signal received from the base station, or when a possibility that a handover will occur is detected because the AWAKE_CNT is greater than or equal to the MAX_AWAKE_CNT, the mobile subscriber station transits to an awake mode and actively participates in the handover process.

Meanwhile, in an IEEE 802.16e communication system, data communication between a mobile subscriber station and a base station is performed wirelessly, and a CINR value measured when the mobile subscriber station is moving may be frequently changed over the passage of time. In other words, the CINR value may temporarily deteriorate and then subsequently improve. Accordingly, it is necessary to understand whether or not the CINR value temporarily deteriorates, or the intensity of a signal (interference component before a handover is performed) from a neighbor base station increases as a distance between the mobile subscriber station and the base station increases before the handover is performed.

Herein, the AWAKE_threshold value, the AWAKE_CNT value and the MAX_AWAKE_CNT value proposed in Table 18 are used in understanding the situation of the mobile subscriber station. Accordingly, when the CINR value measured by the mobile subscriber station is less than the AWAKE_threshold value, the AWAKE_CNT value increases. In contrast, when the CINR value measured by the mobile subscriber station is greater than the AWAKE_threshold value, the AWAKE_CNT value is reset to 0. Also, it is preferred that the AWAKE_CNT value is reset to 0 whenever a listening interval starts.

Meanwhile, the increase of the AWAKE_CNT value signifies that the measured CINR value of the serving base station is continuously less than the AWAKE_threshold value. Finally, when the AWAKE_CNT value is graeter than or equal to the MAX_AWAKE_CNT value, since a probability that a handover will occur becomes stronger, it is inefficient that the mobile subscriber station returns to a sleep mode state again in the conventional sleep mode operation scheme. Instead, it is preferred that the mobile subscriber station transits to an awake mode, continuously measures the CINR, and confirms whether or not the CINR value is greater than the HO_THRESHOLD, that is, the mobile subscriber station must enter a handover process.

Meanwhile, when the AWAKE_CNT value is not zero in the aforementioned comparison of the CINR of the serving base station and the AWAKE_threshold, it cannot be concluded that the channel environment has been actually restored to a normal state even though there may occur a case in which the CINR of the serving base station is greater than the AWAKE_threshold as a rare occurrence.

That is, the aforementioned parameters NORMAL_CNT and MAX_NORMAL_CNT are employed in such circumstances. In other words, when the CINR of the serving base station is greater than the AWAKE_threshold, the NORMAL_CNT increases. In contrast, when the CINR of the serving base station is less than the AWAKE_threshold, the NORMAL_CNT is set to 0. Then, when the NORMAL_CNT continuously increases and thus is greater than or equal to the MAX_NORMAL_CNT, it is determined that the CINR of the serving base station has been stabilized to the extent that a normal communication can be performed. That is, the AWAKE_CNT is set to 0. Further, a variable having been set due to the low level of the CINR of the serving base station is set to be in a normal state. If the AWAKE_CNT directly needs to be set to 0 when the CINR of the serving base station grows greater than the AWAKE_threshold, the MAX_NORMAL_CNT may be set to 1.

As described above, the mobile subscriber station continuously measures the CINR of the serving base station according to a predetermined measurement period during the listening interval, although there may occur a case in which the CINR value has a value less than that of the AWAKE_threshold even at the point at which the listening interval has passed. This is a situation in which communication environments with the serving base station are unfavorable. Also, since such a situation may be regarded as a situation in which a handover must be prepared in advance, the mobile subscriber station must continuously measure the CINR of the serving base station until the measured CINR value of the serving base station is greater than the AWAKE_threshold, even though the AWAKE_CNT is less than the MAX_AWAKE_CNT.

When the measured CINR value of the serving base station grows greater than the AWAKE_threshold and thus the NORMAL_CNT is greater than or equal to the MAX_NORMAL_CNT, the mobile subscriber station transits to a sleep mode again when the mobile subscriber station stays in a sleep interval. Then, the mobile subscriber station measures the CINR again at a timing point at which a next listening interval starts. In contrast, when the measured CINR measured from a listening interval continuously grows less than the AWAKE_threshold due to such a situation, and thus the AWAKE_CNT grows greater than the MAX_AWAKE_CNT in the sleep interval, a possibility that a handover will occur becomes stronger as described above. Accordingly, the subscriber station transits to an awake state in the sleep interval, continuously maintains the awake state, and measures the CINR of the serving base station.

Further, when the CINR value measured for the listening interval becomes small enough to trigger a handover, the subscriber station transits to an awake state and quickly performs the handover. Herein, the aforementioned HO_THRESHOLD is proposed as a value used in determining whether or not the CINR value has become small enough to trigger the handover.

The above description relates to a case in which environments in which a handover can be performed are formed in a sleep mode state. Further, an operation scheme in an awake mode state will be described later.

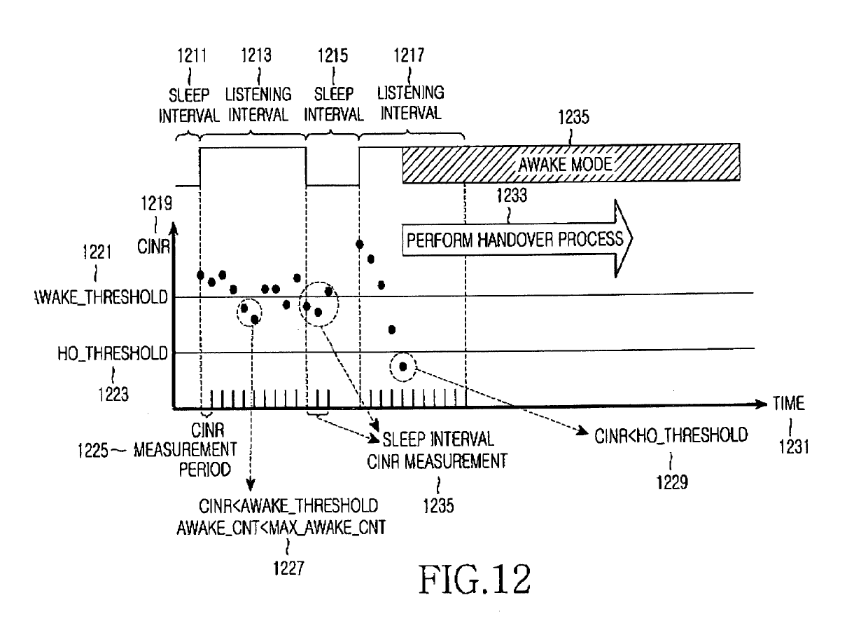

Hereinafter, an operation scheme in the sleep mode state will be described in detail with reference to FIGS. 12 to 14. In the following description, it is assumed that a MAX_NORMAL_CNT is set to 1. Further, a case in which a MAX_NORMAL_CNT is set to have a value greater than 1 will be described in detail with reference to a method according to a second embodiment.

First, a handover process in the sleep mode will be described with reference to FIG. 12.

FIG. 12 is a diagram illustrating the handover process of a mobile subscriber station according to a CINR value measured during a listening interval according to an embodiment of the present invention.

Referring to FIG. 12, the mobile subscriber station periodically measures the CINR of a serving base station for the listening interval. From the result of the measurement, when the measured CINR value grows greater than an HO_THRESHOLD, the mobile subscriber station transits to an awake mode and quickly performs the handover process.

Specifically, the mobile subscriber station stays in the sleep mode, and a predetermined sleep interval and a predetermined listening interval are repeated in the sleep mode as described above. Further, the mobile subscriber station confirms whether or not there exists a message transmitted from the serving base station to the mobile subscriber station in the listening interval. In addition, the mobile subscriber station periodically measures the CINR of the serving base station for the listening interval according to the present invention.

Accordingly, the mobile subscriber station in the sleep mode stays in the sleep mode during the sleep interval 1211. Then, when the listening interval 1213 starts, the mobile subscriber station transits to an awake state for a short interval, and during the CINR measurement period 1225 periodically measures the CINR value 1219 representing the intensity of a signal received from the serving base station during the listening interval 1213.

When the measured CINR value 1219 of the serving base station is less than an AWAKE_THRESHOLD 1221, an AWAKE_CNT value is increased by 1. In contrast, when the measured CINR value 1219 of the serving base station grows greater than the AWAKE_THRESHOLD 1221, the AWAKE_CNT value is initialized to 0. Herein, a MAX_NORMAL_CNT is set to 1.

Meanwhile, when the last CINR measured for the listening interval 1213 is less than the AWAKE_THRESHOLD 1221, the mobile subscriber station continuously measures the CINR value 1219 of the serving base station in a sleep interval 1215 in order to prepare a handover situation even though the listening interval 1213 ends and the sleep interval 1215 starts. When the CINR value 1219 of the serving base station grows greater than the AWAKE_THRESHOLD 1221, the mobile subscriber station returns to the sleep state again because it is still in the sleep interval 1215.

The mobile subscriber station continuously measures the CINR value 1219 again during a listening interval 1217 following the sleep interval 1215. Meanwhile, when the measured CINR value 1219 is less than an HO_THRESHOLD 1223 (as indicated at 1229), the mobile subscriber station determines that it is difficult to communicate with the base station and transits to an awake mode at 1235 for a handover to a neighbor base station even though the mobile subscriber station is still in the sleep mode. Then, the mobile subscriber station transmits a MOB_SSHO_REQ message to the base station, thereby quickly performing the handover process at 1233.

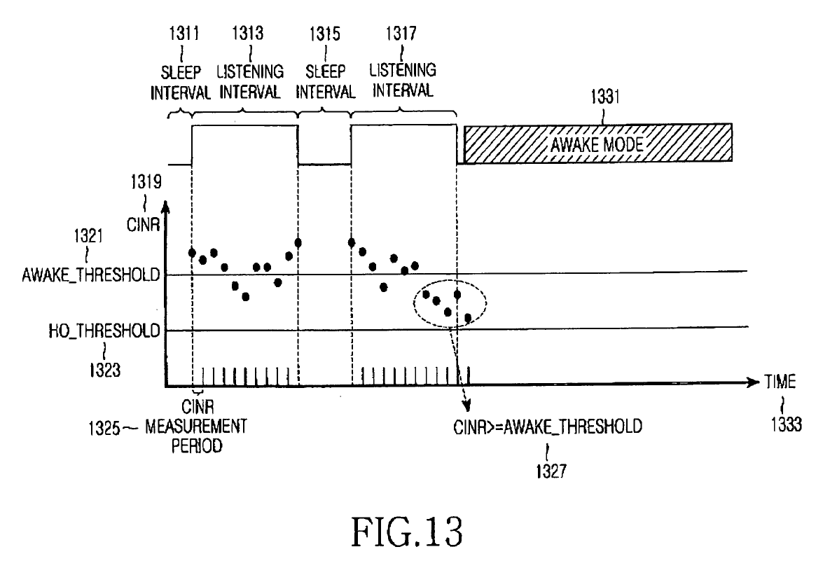

Hereinafter, a process by which a mobile subscriber station transits from a sleep mode to an awake mode when there is a possibility that a handover will occur will be described with reference to FIG. 13. FIG.13 is a diagramillustrates the process by which a mobile subscriber station transits to the awake mode according to a CINR value measured during a listening interval for the handover according to an embodiment of the present invention.

Referring to FIG. 13, the mobile subscriber station periodically measures the CINR of a serving base station for the listening interval 1313. From the result of the measurement, when the CINR value continuously grows less than an AWAKE_THRESHOLD, it is regarded as a state in which handover can occur. Herein, the mobile subscriber station transits to the awake mode and must continuously measure the CINR. Since an operation scheme in the awake mode will be described later, a detailed description is omitted here.

Specifically, the mobile subscriber station in the sleep mode stays in the sleep mode during the sleep interval 1311. Then, when the listening interval 1313 starts, the mobile subscriber station transits to the awake mode for a short interval, and during the CINR measurement period 1325 periodically measures the CINR value 1319 representing the intensity of a signal received from the serving base station during the listening interval 1313. Herein, since an AWAKE_CNT measured during the listening interval 1313 has a value of 2 or 1, the AWAKE_CNT value is less than a preset MAX_AWAKE_CNT value. Accordingly, since it is determined that radio communication environments between the mobile subscriber station and the serving base station deteriorate, the mobile subscriber station proceeds back to a sleep mode 1315 again in the conventional sleep mode operation.

Meanwhile, the mobile subscriber station continuously measures the CINR value again during a listening interval 1317 following the sleep interval 1315. From the result of the measurement, when the CINR value 1319 of the serving base station continuously grows less than an AWAKE_THRESHOLD 1321 and thus the AWAKE_CNT becomes greater than or equal to the MAX_AWAKE_CNT as indicated at 1327, the mobile subscriber station immediately transits to an awake mode 1331 because a possibility that a handover will occur becomes stronger. Then, the mobile subscriber station continuously measures the CINR of the serving base station and actively participates in a handover process which may occur soon afterward.

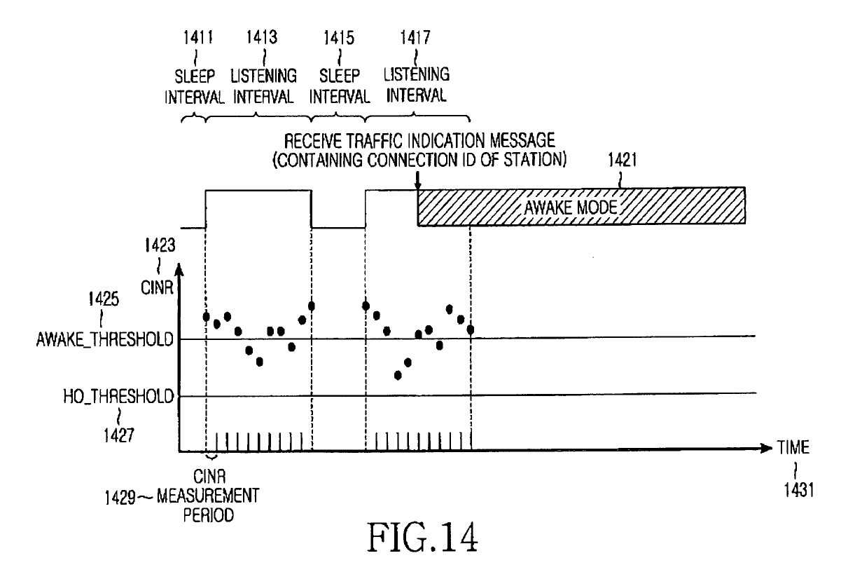

FIG. 14 is a diagram illustrating a process by which a mobile subscriber station transits to an awake mode in consideration of a handover as in the conventional sleep mode operation according to an embodiment of the present invention.

Referring to FIG. 14, the mobile subscriber station periodically measures the CINR of a serving base station for a listening interval. From the result of the measurement, when the measured CINR value does not satisfy the conditions according to which the mobile subscriber station transits to the awake mode as described above, but the mobile subscriber station receives a traffic indication message as in the conventional sleep mode operation, the subscriber station may transit to the awake mode. That is, when a predetermined condition is satisfied in a sleep mode state as described above with respect to FIGS. 12 and 13, the mobile subscriber station may transit to the awake mode. Also, the mobile subscriber station receives the traffic indication message during the sleep mode and may transit to the awake mode as in the conventional method. Accordingly, compatibility with the conventional sleep mode operation can be achieved without an error.

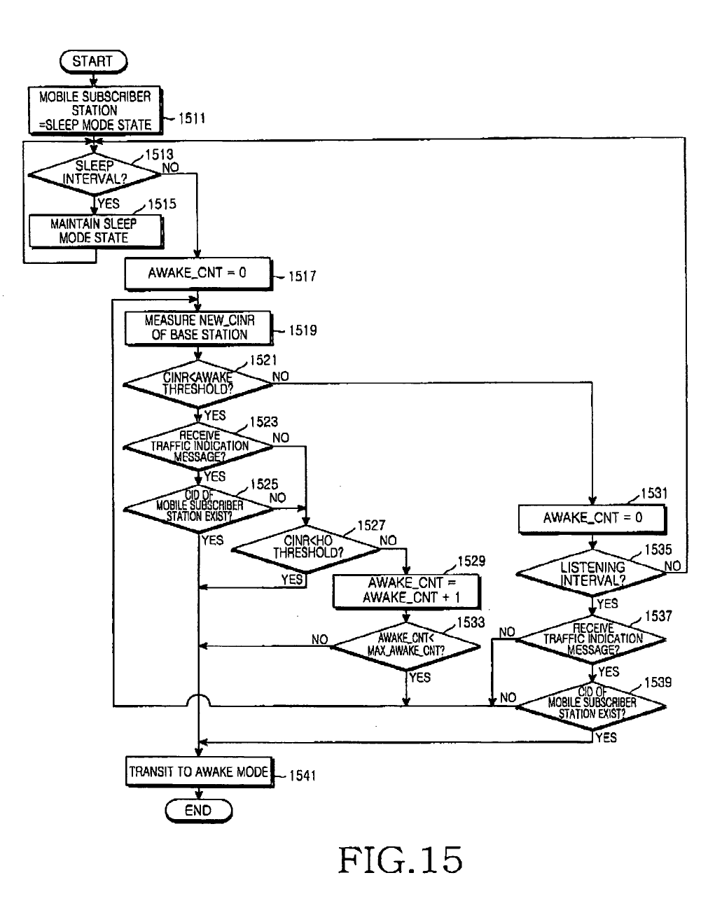

The above description referring to FIGS. 12 to 14 relates to a method by which the mobile subscriber station transits to the awake mode according a to variation of the CINR values of the serving base station periodically measured in the sleep mode. Hereinafter, a procedure by which the mobile subscriber station operates by means of the aforementioned methods is described with reference to FIG. 15.

FIG. 15 is a flowchart illustrating a process by which a mobile subscriber station in a sleep mode transits to an awake mode by a CINR measured during a listening interval in consideration of a handover according to an embodiment of the present invention.

Referring to FIG. 15, the mobile subscriber station remains in the sleep mode in step 1511. Then, in step 1513, the mobile subscriber station determines whether or not a current interval is a sleep interval, that is, whether the mobile subscriber station must stay in the sleep mode. From the result of the determination, when the current interval is not the sleep interval, step 1517 is performed. In contrast, when the current interval is the sleep interval, step 1515 is performed. That is, the mobile subscriber station continuously maintains the sleep mode in step 1515 and proceeds back to step 1513 again.

In step 1517, the mobile subscriber station determines that a listening interval has started and initializes an AWAKE_CNT to 0. Then, in step 1519, the mobile subscriber station measures a new CINR. In step 1521, when the CINR value measured in step 1519 is less than an AWAKE_Threshold, step 1523 is performed. In contrast, when the CINR value is greater than or equal to the AWAKE_Threshold, step 1531 is performed because a communication state between the mobile subscriber station and a base station is favorable.

In step 1531, the mobile subscriber station initializes the AWAKE_CNT to 0. In step 1535, the mobile subscriber station confirms whether or not a current time interval is a listening interval. From the result of confirmation, when the current time interval is the listening interval, step 1537 is performed to confirm whether or not data to be received from the base station exists. In contrast, when the current time interval is not the listening interval, step 1513 is performed because the mobile subscriber station must transit to the sleep mode again.

Meanwhile, in step 1537, the mobile subscriber station confirms whether or not a traffic indication message has been received. From the result of confirmation, when the traffic indication message has been received, step 1539 is performed. In contrast, when the traffic indication message has not been received, the mobile subscriber station proceeds back to step 1519. That is, the mobile subscriber station measures a CINR again. In step 1539, the mobile subscriber station extracts connection IDs from the traffic indication message received in step 1537 and confirms whether or not there exists a connection ID representing the mobile subscriber station. From the result of confirmation, when the connection ID exists, the mobile subscriber station must transit to an awake mode in step 1541. In contrast, when the connection ID does not exist, step 1519 is performed. That is, the mobile subscriber station measures a CINR again.

Meanwhile, in step 1523, the mobile subscriber station confirms whether or not a traffic indication message has been received. From the result of confirmation, when the traffic indication message has been received,in step 1525, the mobile subscriber station extracts connection IDs from the traffic indication message and confirms whether or not there exists a connection ID representing a corresponding subscriber station. From the result of confirmation, when the connection ID exists, step 1541 is performed because there exist data to be transmitted from the base station to the mobile subscriber station. In contrast, when the connection ID does not exist, step 1527 is performed.

In step 1523, if the traffic indication message has not been received, step 1527 is performed. That is, the mobile subscriber station compares the CINR measured in step 1519 with an HO_Threshold. From the result of comparison, when the CINR is less than the HO_Threshold, step 1541 is performed to quickly process a handover.

In contrast, when the CINR is greater than the HO_Threshold, step 1529 is performed because the handover is performed only when the CINR is less than the HO_Threshold. Accordingly, in step 1529, the AWAKE_CNT is increased by 1 and then step 1533 is performed. In step 1533, when the increased AWAKE_CNT value is greater than a MAX_AWAKE_CNT, step 1519 is performed. That is, the mobile subscriber station measures a new CINR again. In contrast, when the increased AWAKE_CNT value is greater than or equal to the MAX_AWAKE_CNT, step 1541 is performed because a possibility that the handover will occur becomes stronger. In step 1541, the mobile subscriber station transits to the awake mode and the procedure is ended.

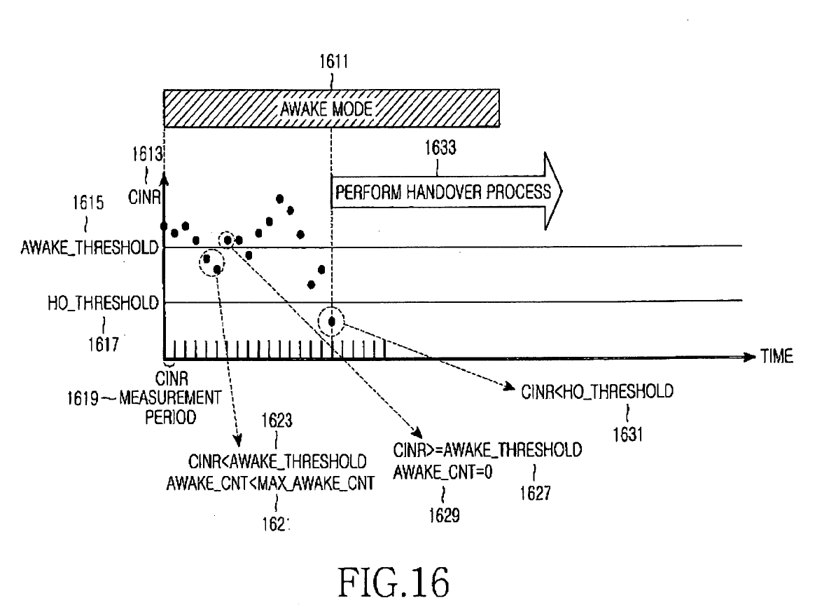

The above description referring to FIGS. 12 to 15 relates to methods according to the present invention, which enables the mobile subscriber station to transit from the sleep mode to the awake mode when a possible situation of a handover occurs. Hereinafter, methods according to the present invention will be described with reference to FIGS. 16 to 20, which enables a mobile subscriber station to maintain an awake mode when a possible situation of a handover occurs.

2) The Handover Procedure in the Awake Mode

In the conventional sleep mode operation, when the mobile subscriber station in the awake mode receives an unsolicited sleep response (‘SLP-RSP’) message from a base station, the mobile subscriber station transits to the sleep mode. When there exists a possibility that the mobile subscriber station in the awake mode will hand over to a neighbor cell controlled by the base station, the mobile subscriber station must maintain the awake mode for a quick handover instead of transiting to the sleep mode even though the base station transmits the unsolicited SLP-RSP message to the mobile subscriber station.

For this reason, in the present invention, instead of transiting to a sleep mode unconditionally when receiving the unsolicited SLP-RSP message in an awake mode, as set forth in the prior art, the mobile subscriber station measures a CINR value representing the intensity of a signal received from the base station. Further, when a handover must be performed because the level of the CINR value is less than the HO_THRESHOLD illustrated in Table 18, or when a possibility that a handover will occur is detected because the AWAKE_CNT value is equal to or greater than the MAX_AWAKE_CNT, the mobile subscriber station is locked in the awake mode and actively participates in the handover.

In addition, even though the AWAKE_CNT value is less than the MAX_AWAKE_CNT, the mobile subscriber station monitors a channel for a handover by means of a NORMAL_CNT, thereby determining whether or not a monitoring state for the handover is released. Therefore, a change to a sleep mode can be set.

As described above, in an IEEE 802.16e communication system, data communication between a mobile subscriber station and a base station is performed wirelessly, and a CINR value measured when the mobile subscriber station is moving may be frequently changed over the passage of time. In other words, the CINR value may temporarily deteriorate and then subsequently improve. Accordingly, when a CINR value measured by the mobile subscriber station is less than an AWAKE_Threshold, an AWAKE_CNT is increased. In contrast, when a case in which the CINR value is continuously greater than the AWAKE_Threshold is detected more than once and thus a NORMAL_CNT is greater than or equal to a MAX_NORMAL_CNT, the AWAKE_CNT is reset to 0. Herein, the increase of the AWAKE_CNT value represents a case in which the measured CINR value is repeatedly less than the AWAKE_Threshold within a predetermined time period. In such a case, when the AWAKE_CNT value is greater than or equal to the MAX_AWAKE_CNT, it signifies that a possibility that a handover will occur becomes stronger. Accordingly, the mobile subscriber station is locked in the awake mode, continuously measures a CINR, and confirms whether or not the measured CINR value falls below an HO_Threshold, that is, the mobile subscriber station must enter a handover process.

Meanwhile, before describing a detailed operation scheme in an awake mode, a message used when the mobile subscriber station must inform the base station of the lock of the awake mode is newly proposed as illustrated in Table 19 below.

TABLE 19

| SYNTAX | SIZE | NOTES |
|---|---|---|
| AWAKE_LOCK_STATE- | | |
| IND_MESSAGE_FORMAT ( ) { | | |
| MANAGEMENT MESSAGE TYPE = 50 | 8 bits | |
| LOCK-FLAG | 8 bits | 1: AWAKE STATE |
| | | LOCKED |
| | | 0: AWAKE STATE |
| | | UNLOCKED |

Referring to Table 19, the AWAKE_LOCK_STATE-IND message, that is, awake lock state indication message is used in order to inform the base station of information signifying that the mobile subscriber station has been locked in the awake mode because a possibility that a handover will occur becomes stronger. Further, when the base station has transmitted an unsolicited SLP-RSP message in a state in which the mobile subscriber station has been locked in the awake mode, the AWAKE_LOCK_STATE-IND message is used in order to inform the base station of information signifying that the mobile subscriber station has been locked in the awake mode. Also, even when the awake mode is released, the AWAKE_LOCK_STATE-IND message is used in order to inform the base station of the release of the awake mode.

Further, when the lock or the release of the awake mode frequently occurs, the AWAKE_LOCK_STATE-IND message may be transmitted only when an unsolicited SLP-RSP message has been received.

Hereinafter, the aforementioned operation method in the awake mode will be described with reference to FIGS. 16 to 18.

FIG. 16 is a view illustrating the handover process of the mobile subscriber station in the awake mode according to a periodically measured CINR value according to an embodiment of the present invention, in which the mobile subscriber station periodically measures the CINR in the awake mode and quickly performs the handover process because the measured CINR value grows less than an HO_Threshold.

Specifically, the mobile subscriber station in the awake mode 1611 periodically 1619 measures the CINR value 1613 representing the intensity of a signal received from the base station. From the result of the measurement, when the measured CINR value 1613 is less than an AWAKE_Threshold 1615, as indicated at 1623, an AWAKE_CNT value is increased by 1. In contrast, when the measured CINR value 1613 grows is greater than or equal to the AWAKE_Threshold 1615, as indicated at 1627, the AWAKE_CNT value is initialized to 0, as indicated at 1629. Herein, when the periodically measured CINR value 1613 is less than an HO_Threshold 1617, it is determined that it is difficult to continuously communicate with the base station. Accordingly, for a handover to a neighbor base station, the subscriber station starts to transmit an MOB_SSHO_REQ message to the base station, and thus quickly performs the handover process at 1633.

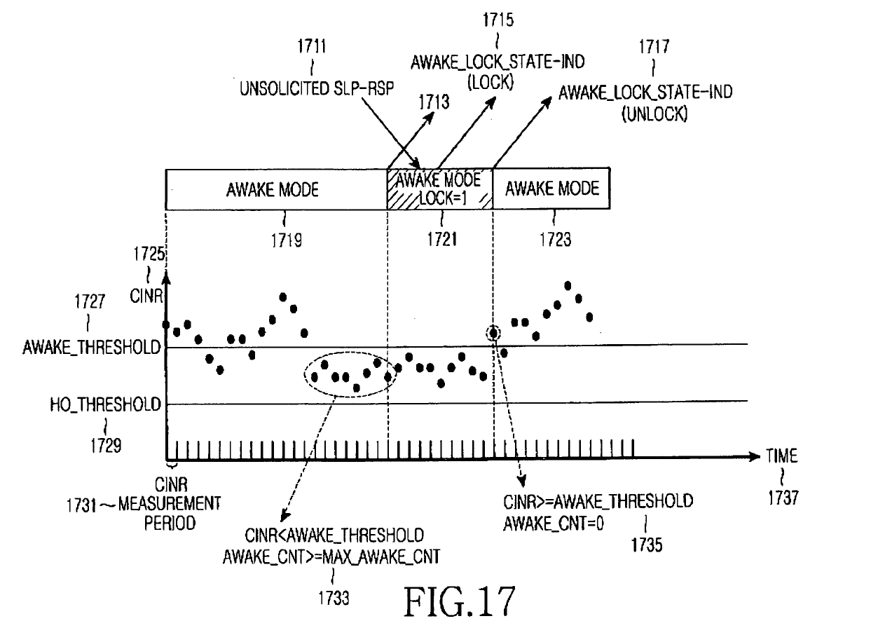

FIG. 17 is a diagram illustrating a process by which a mobile subscriber station is locked in an awake mode for a handover according to a CINR measured during a listening interval in an IEEE 802.16e communication system according to an embodiment of the present invention.

In FIG. 17, the mobile subscriber station in the awake mode periodically measures a CINR, determines that a possibility that handover will occur becomes stronger when a situation in which the measured CINR value is less than an AWAKE_Therehold occurs persistently more than a predetermined number of times, and is thus is locked in the awake mode. Since the lock of the awake mode signifies that the possibility that handover will occur becomes stronger, the mobile subscriber station must deny a transition to a sleep mode even when receiving an unsolicited SLP-RSP message from a base station.

Further, when the awake mode is changed to an awake mode lock or the awake mode lock is changed to the awake mode, the mobile subscriber station uses the AWAKE_LOCK_STATE_‘ND message described in Table 19 in order to inform the base station of the changes. That is, the mobile subscriber station in the awake mode 1719 periodically measures the CINR value 1725 representing the intensity of a signal received from the base station as indicated at 1731.

From the result of the measurement, when a case in which the measured CINR value 1725 is less than the AWAKE_Threshold 1727 continuously occurs and thus an AWAKE_CNT reaches a MAX_AWAKE_CNT as indicated at 1733, the subscriber station is locked in the awake mode 1721 because the possibility that handover will occur becomes stronger. Then, the mobile subscriber station informs the base station of the lock of the awake mode through an AWAKE_LOCK_STATE_IND message 1715.

In the awake mode lock 1721, the mobile subscriber station denies the transition to the sleep mode even though the base station forcibly causes the subscriber station to transit to the sleep mode through the unsolicited SLP-RSP message 1711. Herein, the mobile subscriber station informs the base station of the intention of the denial through an AWAKE-LOCK_STATE_IND message 1715. Meanwhile, when a case in which the periodically measured CINR value is greater than or equal to the AWAKE_Threshold occurs as indicated at 1735, the awake mode lock 1721 is changed to a general awake mode 1723. The mobile subscriber station informs the base station of the change through an AWAKE_LOCK_STATE_IND message 1717.

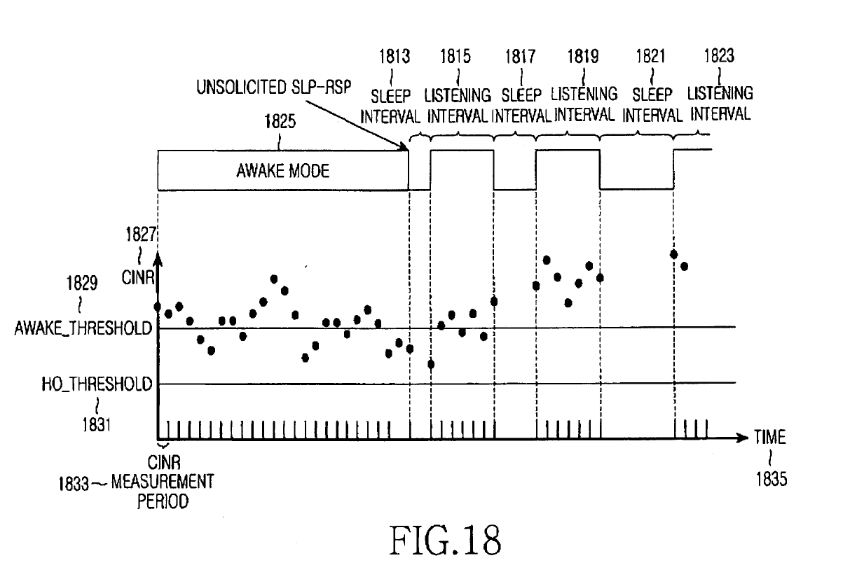

FIG. 18 is a diagram illustrating a process by which a mobile subscriber station transits to a sleep mode in consideration of a handover as in the conventional sleep mode operation according to an embodiment of the present invention.

In FIG. 18, the mobile subscriber station in an awake mode periodically measures a CINR and the measured CINR value does not satisfy conditions according to which the mobile subscriber station transits to the awake mode, but the mobile subscriber station transits to the sleep mode according to the reception of the unsolicited SLP-RSP message as in the conventional sleep mode operation. Accordingly, compatibility with the existing sleep mode operation can be accomplished.

That is, when the mobile subscriber station staying in the awake mode 1825 receives the unsolicited SLP-RSP message, the mobile subscriber station transits to the sleep mode as in the prior art. Herein, as described above, the mobile subscriber station measures a CINR of a serving base station during listening intervals 1815, 1819, and 1823 of the awake mode or the sleep mode, and determines a handover situation according to the measured CINR value.

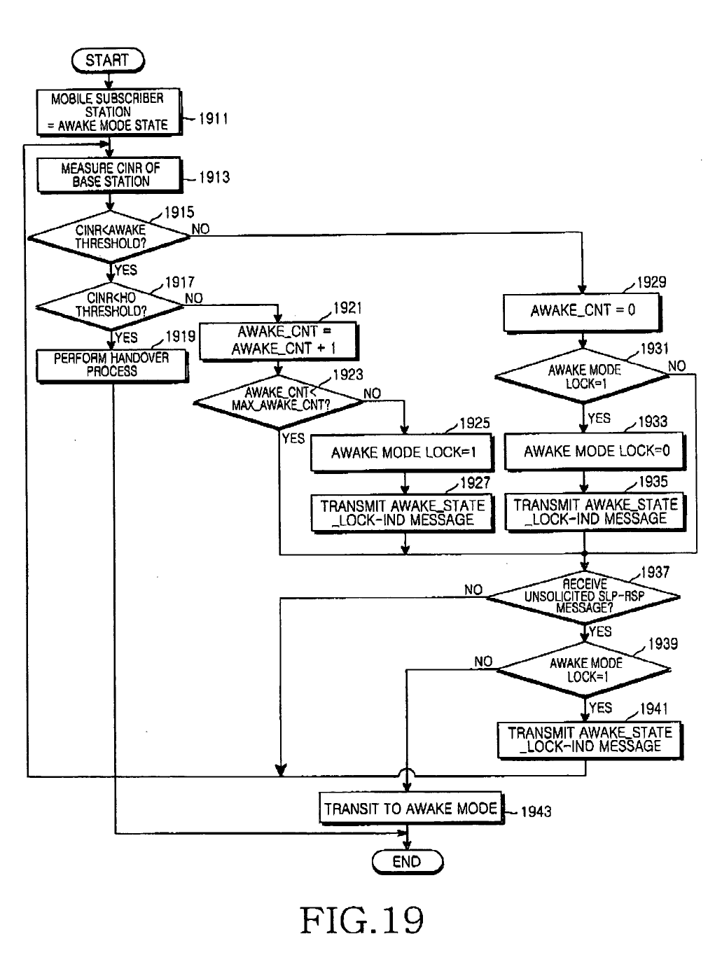

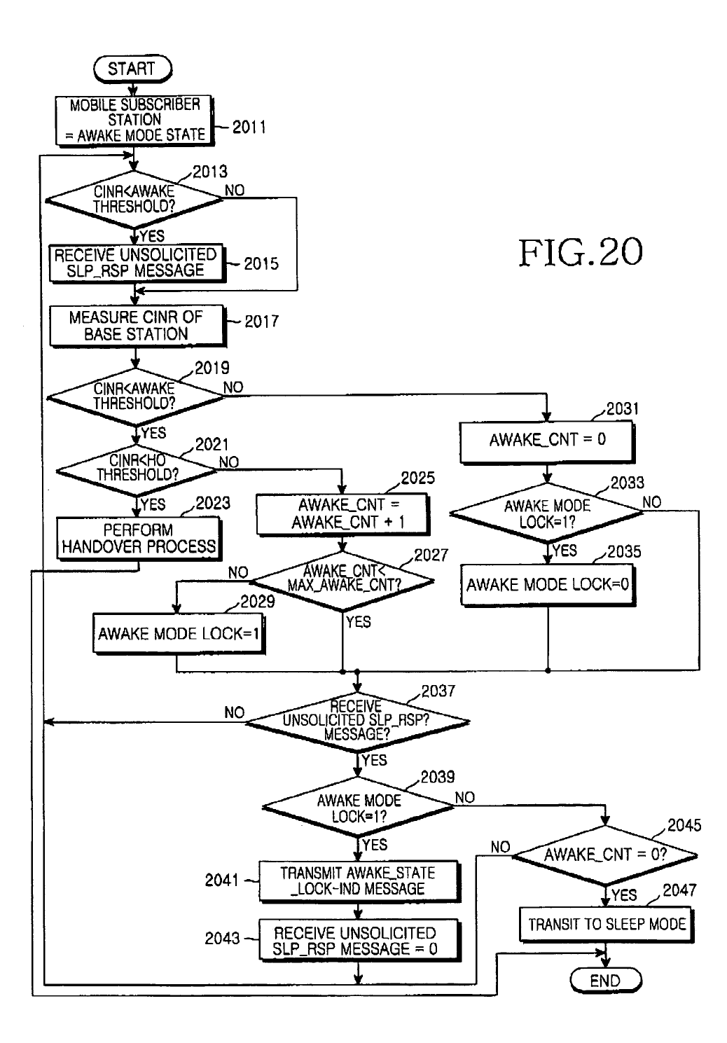

The above description referring to FIGS. 16 to 18 relates to a method for realizing the present invention in the awake mode. Hereinafter, a procedure by which the mobile subscriber station performs the method will be described with reference to FIGS. 19 and 20.

FIG. 19 is a flowchart illustrating a process according to an embodiment of the present invention, which enables a mobile subscriber station in an awake mode to transit to a sleep mode considering a handover in a state change for a sleep mode transition.

Referring to FIG. 19, the mobile subscriber station remains in the sleep mode in step 1911. In step 1913, the mobile subscriber station measures a CINR of a base station. In step 1915, the mobile subscriber station compares the CINR measured in step 1913 with an AWAKE_Threshold. From the result of the comparison, when the measured CINR is less than the AWAKE_Threshold, step 1917 is performed.

In contrast, when the measured CINR is greater than or equal to the AWAKE_Threshold, that is, when a communication state between the mobile subscriber station and the base station is favorable, step 1929 is performed. In step 1929, an AWAKE_CNT is initialized to 0. In step 1931, it is determined whether or not the state of the mobile subscriber station is an awake mode lock. From the result of the determination, when the state of the mobile subscriber station is the awake mode lock, step 1933 is performed.

In step 1933, the state of the mobile subscriber station is changed to a general awake mode, that is, the awake mode lock value is set to 0, and in step 1935, the mobile subscriber station transmits an AWAKE_LOCK_STATE_IND message in order to inform the base station of the fact that the state of the mobile subscriber station has changed from the awake mode lock to the awake mode. Then, step 1937 is performed.

Meanwhile, in step 1917, it is determined whether or not the measured CINR is less than an HO_Threshold. From the result of the determination, when the CINR has a value less than that of the HO_Threshold, step 1919 is performed for a quick completion of a handover. In step 1919, a handover process is started.

In contrast, when the CINR is greater than the HO_Threshold, step 1921 is performed. In step 1921, an AWAKE_CNT value, which is a parameter for determining a possibility that a handover will occur, is increased by 1. In step 1923, the subscriber station compares the increased AWAKE_CNT with a MAX_AWAKE_CNT and confirms the possibility that the handover will occur.

From the result of the comparison, when the AWAKE_CNT is less than the MAX_AWAKE_CNT, step 1937 is performed. In contrast, when the AWAKE_CNT is greater than the MAX_AWAKE_CNT, step 1925 is performed because the possibility that the handover will occur becomes stronger. In step 1925, for a smooth handover excluding a request to a sleep mode transition by the base station, the state of the mobile subscriber station is set to be an awake mode lock, that is, the awake mode lock value is set to 1, and step 1927 is performed. In step 1927, the mobile subscriber station transmits an AWAKE_LOCK_STATE_IND message in order to inform the base station of the fact that the state of the mobile subscriber station has changed from the awake mode to the awake mode lock. Then, step 1937 is performed.

After performing the aforementioned series of steps, in step 1937, it is confirmed whether or not an unsolicited SLP-RSP message signifying that the base station requests a transition to a sleep mode of the mobile subscriber station has been received. From the result of the confirmation, when the unsolicited SLP-RSP message has been received, step 1939 is performed. In contrast, when the unsolicited SLP-RSP message has not been received, the mobile subscriber station proceeds back to step 1913. That is, the mobile subscriber station again measures the CINR of the base station.

In step 1939, it is confirmed whether or not the state of the mobile subscriber station is an awake mode lock, that is, the awake mode value has a fixed value of 1. From the result of the confirmation, when the state of the mobile subscriber station is the awake mode lock, it signifies that the base station requests the transition to the sleep mode of the mobile subscriber station in a state in which a possibility that a handover will occurs becomes stronger. Accordingly, step 1941 is performed and the mobile subscriber station must deny the transition to the sleep mode. In step 1941, the mobile subscriber station transmits an AWAKE_LOCK_STATE_IND message in order to inform the base station of the denial of the transition to the sleep mode. Then, the mobile subscriber station proceeds back to step 1913. That is, the mobile subscriber station measures the CINR of the base station again.

Meanwhile, when the state of the mobile subscriber station is the general awake mode, step 1943 is performed because it is the same as that of the conventional sleep mode operation scheme. That is, the mobile subscriber station transits to the sleep mode. Then, the procedure is ended.

FIG. 20 is a flowchart illustrating a process according to an embodiment of the present invention, which enables a mobile subscriber station in an awake mode to transit to a sleep mode in consideration of a handover in a state change for a sleep mode transition.

Referring to FIG. 20, the mobile subscriber station remains in the sleep mode in step 2011. For steps following step 2011, a description of steps identical to those of FIG. 19 will be briefly given or omitted, and steps different from those of FIG. 19 will be described. That is, the mobile subscriber station in an awake mode transits to an awake mode lock by a periodically measured CINR in consideration of a handover. Herein, in contrast with steps 1927 and 1935 of FIG. 19, a message transmission to a base station according to the transition to the awake mode lock is not performed. Instead, in step 2037, it is determined whether or not an unsolicited SLP-RSP message has been received. If so, in step 2039, it is determined whether or not the state of the mobile subscriber station is the awake mode lock. From the result of the determination, when the state of the mobile subscriber station is the awake mode lock, the mobile subscriber station transmits an AWAKE_LOCK_STATE_IND message in step 2041.

Meanwhile, in FIG. 20, the unsolicited SLP-RSP message is received in step 2015. Further, it is determined whether or not an AWAKE_CNT has a value of 0 in step 2045 even though the state of the mobile subscriber station is not the awake mode lock in step 2039. From the result of the determination, when the AWAKE_CNT does not have a value of 0, step 2013 is performed. That is, the mobile subscriber station continuously measures the CINR of the base station. In contrast, only when it is determined that the AWAKE_CNT has a value of 0, step 2047 is performed. That is, the mobile subscriber station transits to the sleep mode.

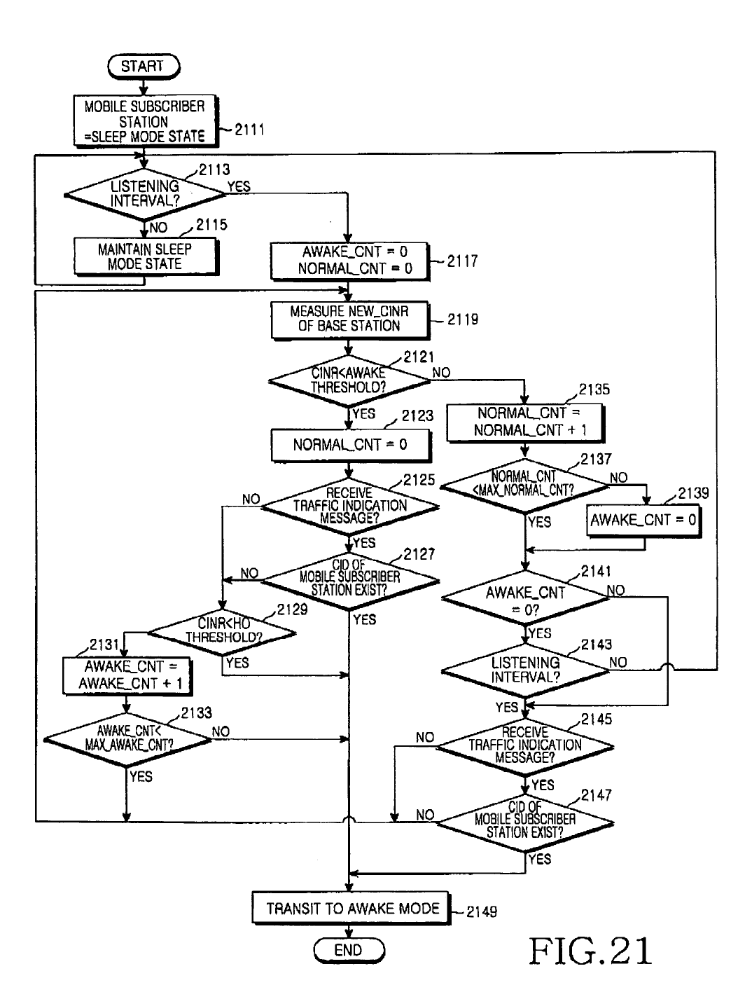

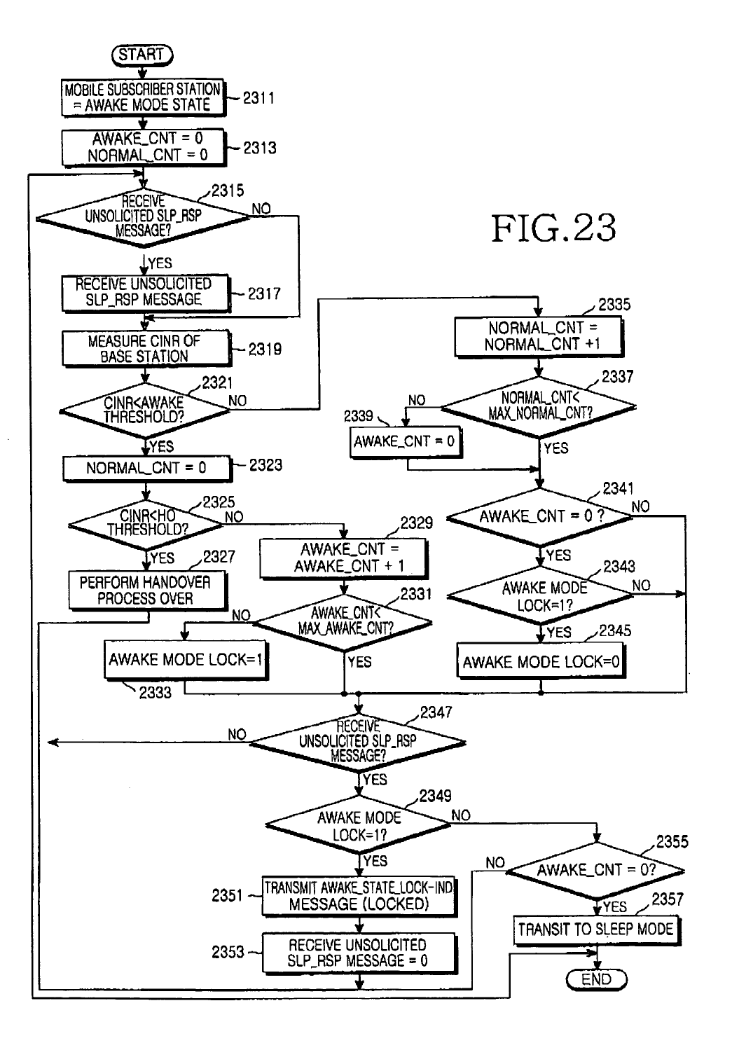

The above description relates to respective methods and procedures according to the occurrence of handover situations in the sleep mode and the awake mode. Hereinafter, embodiments when a NORMAL_CNT and a MAX_NORMAL_CNT are applied to the aforementioned procedures will be described with reference to FIGS. 21 and 23.

FIG. 21 is a flowchart illustrating a procedure according to an embodiment of the present invention, which enables a mobile subscriber station in a sleep mode to transit to an awake mode in consideration of a handover including a normal state restoration according to a repetition detection.

The present embodiment of FIG. 21 is a case in which a NORMAL_CNT and a MAX_NORMAL_CNT are applied to the embodiment of FIG. 15. In describing FIG. 21, a description of steps identical to those of FIG. 15 will be briefly given or omitted. Further, a MAX_CNT used in step 2137 of FIG. 21 has the same value as that of the MAX_NORMAL_CNT. Steps added in FIG. 21 in comparison with FIG. 15 are as follows: a step of increasing the NORMAL_CNT when the CINR is greater than the AWAKE_Threshold (step 2135); a step of setting the NORMAL_CNT to have a value of 0 again when the CINR is less than the AWAKE_Threshold (step 2123); and a step of setting related variables so that the mobile subscriber station can come back to a normal state, when the NORMAL_CNT is greater than or equal to the MAX_NORMAL_CNT as a result of comparison between the NORMAL_CNT and the MAX_NORMAL_CNT (step 2137).

Referring to FIG. 21, when it is determined that a current interval is a listening interval in step 2113, the AWAKE_CNT and the NORMAL_CNT are newly set to be 0 at step 2117. In step 2119, the new CINR of a base station is measured.

Meanwhile, in step 2121, when the CINR is less than the AWAKE_Threshold, the NORMAL_CNT are set to 0 in step 2123. Then, step 2125 is performed. In contrast, when the CINR is greater than the AWAKE_Threshold, the NORMAL_CNT value is increased by 1. Then, step 2137 is performed. In step 2137, it is determined whether or not the increased NORMAL_CNT is equal to or greater than the MAX_CNT. According to the result of the determination, the AWAKE_CNT is set to 0. Then, step 2141 is performed. Steps 2143, 2145 and 2147 after step 2141 are identical to steps 1535, 1537, and 1539 of FIG. 15.

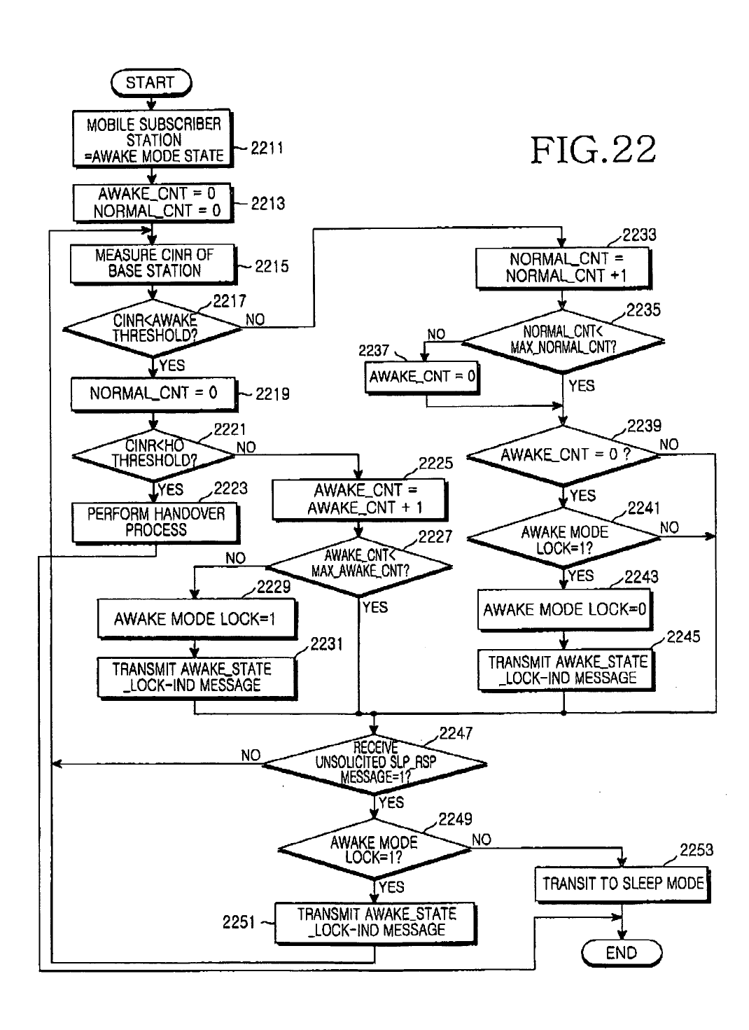

FIG. 22 is a flowchart illustrating a procedure according to an embodiment of the present invention, which enables a mobile subscriber station in an awake mode to transit to a sleep mode in a state change for a sleep mode transition in consideration of a handover including a normal state restoration according to a repetition detection. That is, FIG. 22 is a flowchart illustrating a state-transition process to an awake mode lock and the sleep mode from the awake mode when a NORMAL_CNT and MAX_NORMAL_CNT are applied to the embodiment of FIG. 19.

Further, FIG. 23 is a flowchart illustrating a procedure according to an embodiment of the present invention, which enables a mobile subscriber station in an awake mode to transit to a sleep mode in a state change for a sleep mode transition in consideration of a handover including a normal state restoration according to a repetition detection. That is, FIG. 23 is a flowchart illustrating a state-transition process to an awake mode lock and the sleep mode from the awake mode when a NORMAL_CNT and a MAX_NORMAL_CNT are applied to the embodiment of FIG. 20.

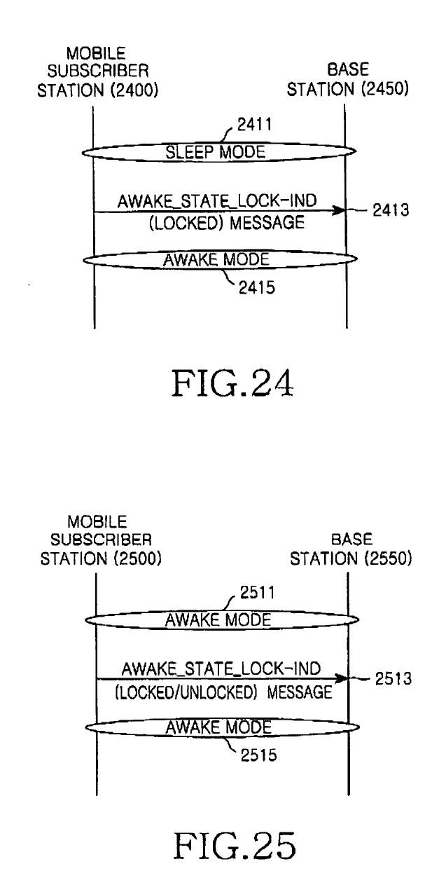

Accordingly, since a use operation of the NORMAL_CNT and the MAX_NORMAL_CNT of FIGS. 22 and 23 is the same as that described in FIG. 21, a detailed description is omitted. Hereinafter, mode change procedures according to the aforementioned embodiments will be described with reference to FIGS. 24 to 26.

FIG. 24 is a flowchart illustrating a case in which a mobile subscriber station in a sleep mode transmits an AWAKE_STATE_LOCK_IND message containing the lock state indication of an awake mode to a base station.

That is, FIG. 24 is a flowchart illustrating an operation by which the mobile subscriber station transmits a message relating to a state-transition to a base station and transits to the awake mode, when the mobile subscriber station transits from the sleep mode to the awake mode and then the mobile subscriber station must inform the base station of the transition to the awake mode, according to the present invention. FIG. 24 illustrates a case in which the AWAKE_STATE_LOCK_IND message used in the awake mode is used. Herein, the operation in the awake mode according to the present invention can be differently performed by transmitting the AWAKE_STATE_LOCK_IND message containing a locked state or an unlocked state.

FIG. 25 is a signal flowchart illustrating a process by which a mobile subscriber station transmits an AWAKE_STATE_LOCK_IND message to a base station in step 2513 when an awake mode is changed to an awake mode lock state, or the awake mode lock state is released resulting in a change in the awake mode lock state.

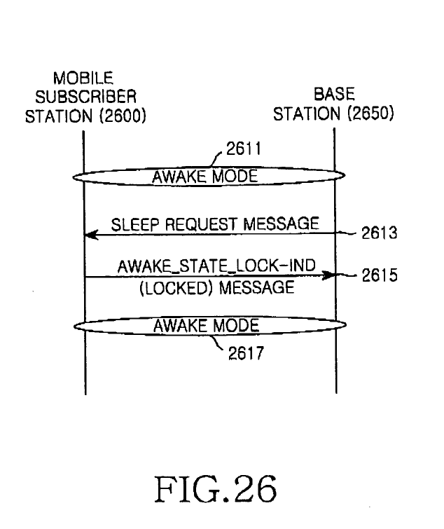

Further, FIG. 26 is a signal flowchart illustrating a process by which a mobile subscriber station transmits an AWAKE_STATE_LOCK_IND message and continuously stays in an awake mode of step 2611 when an unsolicited SLP-RSP message is received from a base station in step 2613 in a state in which an awake mode has been changed to an awake mode lock state.

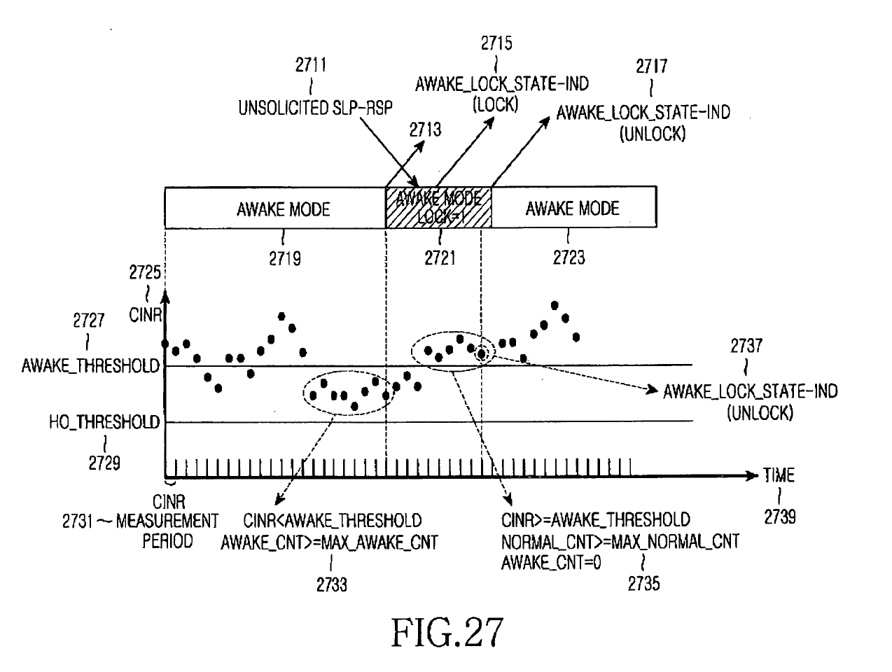

FIG. 27 is a diagram illustrating a process by which a signal flowchart subscriber station in an awake mode denies a state-transition to a sleep mode by the control of a base station and stays in an awake mode in the lock state of the awake mode according to a periodically measured CINR value.

According to an embodiment of the present invention, FIG. 27 illustrates a case in which a signal flowchart subscriber station in an awake mode transmits an AWAKE_STATE_LOCK_IND (LOCK) message even though an unsolicited SLP-RSP message has been received from a base station when CINR values have been periodically measured and an awake mode lock has been set according to the measured CINR values, as described in FIG. 17.

When a NORMAL_CNT is used, the NORMAL_CNT is greater than or equal to a MAX-NORMAL_CNT, and thus an AWAKE_CNT is set to 0 in step 2735. Further, the signal flowchart subscriber station transmits an AWAKE_STATE_LOCK_IND (UNLOCK) message to the base station in step 2717.

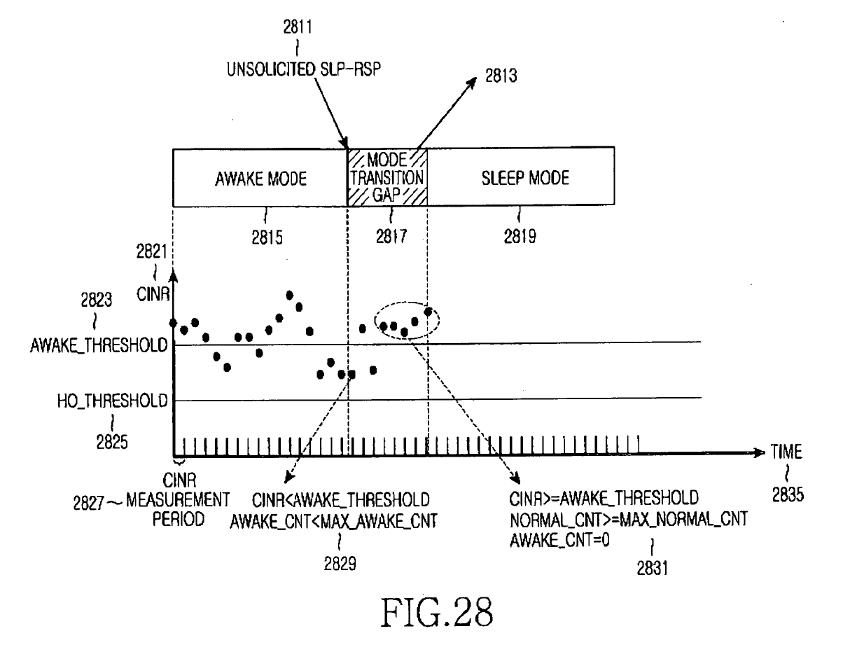

FIG. 28 is a diagram illustrating a process by which a signal flowchart subscriber station in an awake mode periodically measures CINR values and receives an unsolicited SLP-RSP message from a base station in a state in which an awake mode lock is not set according to the measured CINR values, according to an embodiment of the present invention. When an AWAKE_CNT is greater than 0 in step 2829, the mobile subscriber station does not transit to a sleep mode. Then, when a NORMAL_CNT is greater than or equal to the MAX_NORMAL_CNT, the subscriber station sets the AWAKE_CNT to 0 by means of the NORMAL_CNT, and transits to the sleep mode.

As described above, the present invention simultaneously supports both a sleep mode operation and an awake mode operation and a handover process of a broadband wireless access communication system employing an OFDM/OFDMA scheme, that is, an IEEE 802.16e communication system. Detailed advantages when considering the sleep mode operation/the awake mode operation and the handover process are as follows:

1) An IEEE 802.16e communication system must ensure both the minimization of power consumption and the mobility of a mobile subscriber station. Accordingly, in the present invention, a mobile subscriber station in an awake mode periodically measures CINR values, and persistently maintains the awake mode in radio environments, in which a possibility that a handover will occur becomes stronger, according to the measured CINR values, thereby forming conditions by which a quick handover can be performed. Therefore, maximum QoS of data traffic can be ensured;

2) In prior art systems, the mobile subscriber station having been in the sleep mode state awakens in an awake state for a short interval during a listening interval, receives a traffic indication message, and confirms whether or not data from a base station exists and a connection ID of the mobile subscriber station exists. When the connection ID does not exist, the mobile subscriber station returns to a sleep mode again, increases an existing sleep interval twice, and stays in the sleep mode state. Further, when the mobile subscriber station has moved into a cell controlled by a neighbor base station due to being located in a vehicle or other movable bodies, the mobile subscriber station does not recognize the movement to the cell and awakes in an awake node state again for a short interval in order to confirm whether or not data from an existing base station exists during a listening interval after a sleep interval. Then, the mobile subscriber station tries a synchronization to the downlink signal of the existing base station. However, since the mobile subscriber station has already moved into the neighbor cell using another frequency band, all configuration information and a data traffic connection with the existing base station having provided a service are regarded as invalid information. Accordingly, the mobile subscriber station must perform an initial process with the neighbor base station again. Further, since the mobile subscriber station has moved into the neighbor cell without a normal handover process, the existing base station having provided the service recognizes that the mobile subscriber station still stays in a cell controlled by the base station. Therefore, a disagreement of status information occurs. Accordingly, in the present invention, the mobile subscriber station measures a CINR for the listening interval and transits to an awake mode according to the measured CINR value when there exists a possibility that a handover will occur during a sleep interval, even though a handover does not occur. Therefore, a handover can be quickly performed without the problems as described above; and

3) Even though the operation in the steps is performed, the change of CINRs frequently occurs when a change of channels frequently occurs. Further, the rapid change of states due to the change of CINRs may cause transmission of many additional messages between a base station and a mobile subscriber station. In the present invention, only when CINRs of a desired state are repeatedly detected through the repeated detection of the CINRs, the mobile subscriber station performs a mode-transition. Accordingly, the mobile subscriber station can maintain a desired state according to a preset value even though the change of channels occurs.

While the invention has been shown and described with reference to certain preferred embodiments thereof, it will be understood by those skilled in the art that various changes in form and details may be made therein without departing from the spirit and scope of the invention as defined by the appended claims.

1. A method for enabling a mobile subscriber station to transit from a sleep mode to an awake mode in a broadband wireless access communication system including the sleep mode in which there exists no data to be transmitted between the mobile subscriber station and a base station, and the awake mode in which there exists data to be exchanged between the mobile subscriber station and the base station, the method comprising the steps of:
measuring a signal quality in a predetermined time interval during the sleep mode; and
transiting from the sleep mode to the awake mode when the measured signal quality is less than a first threshold value

2. The method as claimed in claim 1, wherein the signal quality is a Carrier-to-Interference and Noise Ratio(CINR).

3. The method as claimed in claim 1, wherein the first threshold value is a Carrier-to-Interference and Noise Ratio(CINR) used as a determination condition for maintenance of the awake mode of the mobile subscriber station.

4. The method as claimed in claim 1, further comprising the step of performing a handover when the measured signal quality is less than a second threshold, wherein the second threshold value is less than the first threshold value.

5. The method as claimed in claim 1, wherein the measurement of the signalquality is performed periodically in each predetermined time interval for monitoring the signal.

6. The method as claimed in claim 1, wherein the mobile subscriber station transits from the sleep mode to the awake mode when the measured signal quality is less than the first threshold value by a predetermined number of times and the number of times arrives at a preset maximum allowed value.

7. The method as claimed in claim 7, wherein the mobile subscriber station continuously measures the signal quality when a last measured signalquality is less than the first threshold value in even a case in which a number of times of a repetition of the first threshold value does not arrive at the maximum allowed value and the time interval for monitoring the signal has ended.

8. The method as claimed in claim 1, wherein the mobile subscriber station transits from the sleep mode to the awake mode when receiving a traffic indication message from the base station in the time interval for monitoring the signal during the sleep mode.

9. The method as claimed in claim 1, further comprising the step of increasing an awake count value by 1 when the measured signal quality is less than the first threshold value.

10. The method as claimed in claim 1, further comprising the step of setting an awake count value to 0 when the measured signal quality is greater than the first threshold value.

11. The method as claimed in claim 1, further comprising the step of increasing a normal count value by 1 when the measured signal quality is greater than or equal to the first threshold value.

12. The method as claimed in claim 11, wherein the normal count value is a value for releasing an awake mode lock state.

13. The method as claimed in claim 1, further comprising the step of setting a normal count value to 0 when the measured signal quality is less than the first threshold value.

14. A method for enabling a mobile subscriber station to maintain an awake mode in a broadband wireless access communication system including a sleep mode in which there exists no data to be transmitted between the mobile subscriber station and a base station, and the awake mode in which there exists data to be exchanged between the mobile subscriber station and the base station, the method comprising the steps of:
measuring a signal quality; and
setting a state of the mobile subscriber station to be an awake mode lock state to maintain the awake mode when the measured signal quality is less than a first threshold value.

15. The method as claimed in claim 14, wherein the signal quality is a Carrier-to-Interference and Noise Ratio(CINR).

16. The method as claimed in claim 14, wherein the threshold value is a signal quality used as a determination condition for maintenance of the awake mode of the mobile subscriber station.

17. The method as claimed in claim 14, further comprising the step of performing a handover when the measured signal quality is less than a second threshold value, wherein the second threshold value is less than the first threshold value.

18. The method as claimed in claim 14, wherein the measurement of the signal quality is performed periodically in each predetermined interval of the awake mode.

19. The method as claimed in claim 14, wherein the state of the subscriber station is set to be the awake mode lock state to maintain the awake mode when the measured signal quality is less than the first threshold value by a predetermined number of times and the number of times arrives at a preset maximum allowed value.

20. The method as claimed in claim 14, wherein, after the state of the mobile subscriber station has been set to be the awake mode lock state, the mobile subscriber station notifies the base station of the setting to the awake mode lock state through a predetermined message.

21. The method as claimed in claim 20, wherein the message reporting the setting to the awake mode lock state is an awake state lock indication message.

22. The method as claimed in claim 14, wherein the mobile subscriber station maintains the awake mode when receiving a message indicating an unsolicited transition to a sleep mode after the state of the mobile subscriber station has been set to the awake mode lock state.

23. The method as claimed in claim 14, wherein the mobile subscriber station notifies the base station that the state of the mobile subscriber station is the awake mode lock state when receiving a message indicating an unsolicited transition to a sleep mode.

24. The method as claimed in claim 14, further comprising the step of increasing an awake count value by 1 when the measured signal quality is less than the first threshold value.

25. The method as claimed in claim 14, further comprising the step of setting to 0 when the measured signal quality is greater than the first threshold value.

26. The method as claimed in claim 14, further comprising the step of increasing an awake count value by 1 when the measured signal quality is less than the first threshold value.

27. The method as claimed in claim 14, further comprising the step of setting an awake count value to 0 when the measured signal quality is greater than the first threshold value.

28. The method as claimed in claim 14, wherein further comprising the step of increasing a normal count value by 1 when the measured signal quality is greater than or equal to the first threshold value.

29. The method as claimed in claim 28, wherein the normal count value is a value for releasing an awake mode lock state.

30. The method as claimed in claim 14, further comprising the step of setting a normal count value to 0 when the measured signal quality is less than the first threshold value.
